(19) United States
(12) Patent Application Publication
(10) Pub. No.: US 2024/0048363 A1
(43) Pub. Date: Feb. 8, 2024

(54) NETWORK PACKET TAMPERING PROOFING

(71) Applicant: WINKK, INC, Menlo Park, CA (US)

(72) Inventor: Robert O. Keith, Jr., San Jose, CA (US)

(21) Appl. No.: 18/371,003

(22) Filed: Sep. 21, 2023

Related U.S. Application Data
(63) Continuation-in-part of application No. 17/542,156, filed on Dec. 3, 2021.
Application No. 17/542,156 is a continuation-in-part of application No. 17/040,949, filed on Sep. 23, 2020, now Pat. No. 11,637,694.
(60) Provisional application No. 62/698,644, filed on Jul. 16, 2018.

(51) Int. Cl. H04L 9/08; H04L 9/06

(52) U.S. Cl. CPC H04L 9/0825; H04L 9/0891; H04L 9/0643

(57) ABSTRACT

Aspects of associative cryptography key operations are described. In one embodiment, a first cryptographic function is applied to secret data to produce a first encrypted result. The first encrypted result is transmitted by a first device to a second device. The second device applies a second cryptographic function to the first encrypted result to produce a second encrypted result. At this point, the secret data has been encrypted by two different cryptographic functions, each of them being sufficient to secure the secret data from others. The two different cryptographic function can be inversed or removed, in any order, to reveal the secret data. Thus, the first device can apply a first inverse cryptographic function to the second encrypted result to produce a first result, and the second device can apply a second inverse cryptographic function to the first result to decrypt the secret data.

### CROSS-REFERENCE TO RELATED APPLICATION(S)

This application is a continuation-in-part application of co-pending U.S. patent application Ser. No. 17/542,156, filed on Dec. 3, 2021, and titled “LOW POWER ENCRYPTION IN MOTION,” which is a continuation-in-part application of co-pending U.S. patent application Ser. No. 17/040,949, filed on Sep. 23, 2020, and titled “SECRET MATERIAL EXCHANGE AND AUTHENTICATION CRYPTOGRAPHY OPERATIONS,” which claims priority to PCT Application No. PCT/US2019/041871, filed on Jul. 15, 2019, and titled “SECRET MATERIAL EXCHANGE AND AUTHENTICATION CRYPTOGRAPHY OPERATIONS,” which claims priority to U.S. Provisional Patent Application No. 62/698,644, filed on Jul. 16, 2018, and titled “SECRET MATERIAL EXCHANGE AND AUTHENTICATION CRYPTOGRAPHY OPERATIONS,” which are all hereby incorporated by reference in their entireties for all purposes.

### BACKGROUND

Cryptography is related to the study of protocols, techniques, and approaches that prevent third parties from accessing, reading, and/or interpreting secret data. Cryptography can be applied to various processes in information security, such as data integrity and encryption, confidentiality, authentication, verification, and non-repudiation. Thus, cryptography has several applications in various fields, including data encryption and privacy, computer network communications and transaction processing, and computing system security and integrity.

Modern cryptography often relies upon computational hardness in mathematical theory. In other words, it might be theoretically possible to break certain cryptographic systems, but the time required to do so makes such cryptographic-defeating processes intractable. Typically, computationally-secure cryptography processes are preferable to those which are easier to defeat. At the same time, however, computationally-secure cryptography processes might be more computationally-intensive to implement and, thus, more time consuming and costly. In that context, although some cryptographic processes, such as a one time pad, cannot be broken or defeated even with unlimited computing power, those schemes are more difficult to implement than a good, theoretically-breakable but computationally secure approach. As such, modern computing devices may exchange secret data using cryptographic processes having security problems (e.g., the processes are susceptible to brute force attack). At the same time, those cryptographic processes may be resource intensive (e.g., the processes are computationally-intensive to implement).

### SUMMARY

Aspects of associative cryptography key operations are described. In one embodiment, a first cryptographic function is applied to secret data to produce a first encrypted result. The first encrypted result is transmitted by a first device to a second device. The second device applies a second cryptographic function to the first encrypted result to produce a second encrypted result. At this point, the secret data has been encrypted by two different cryptographic functions, each of them being sufficient to secure the secret data from others. The two different cryptographic function can be inversed or removed, in any order, to reveal the secret data. Thus, the first device can apply a first inverse cryptographic function to the second encrypted result to produce a first result, and the second device can apply a second inverse cryptographic function to the first result to decrypt the secret data.

In one aspect, a method comprises implementing a matrix-based authentication communication between a low power device and a second device and sending a plurality of messages between the low power device and the second device before performing an additional matrix-based authentication communication. The low power device comprises an Internet of Things device. The low power device includes a battery which is charged initially and then is charged using ambient light and/or signals/waves. The method further comprises counting, using a counter on the low power device, to determine when to perform the additional matrix-based authentication communication. The method further comprises utilizing a clock to determine when to perform the next matrix-based key authentication communication. The matrix-based authentication communication utilizes real numbers and white noise. The matrix-based authentication communication utilizes a plurality of matrices and non-linear equations. The method further comprises listening for a response, with the low power device for a period of time, after sending a communication to the second device, and then sleeping the low power device after the period of time has expired.

In another aspect, an apparatus comprises a memory for storing an application, the application configured for: implementing a matrix-based authentication communication with a second device and sending a plurality of messages to the second device before performing an additional matrix-based authentication communication and a processor configured for processing the application. The apparatus comprises an Internet of Things device. The apparatus further comprises a battery which is charged initially and then is charged using ambient light and/or signals/waves. The application is further configured for counting, using a counter on the low power device, to determine when to perform the additional matrix-based authentication communication. The application is further configured for utilizing a clock to determine when to perform the next matrix-based key authentication communication. The matrix-based authentication communication utilizes real numbers and white noise. The matrix-based authentication communication utilizes a plurality of matrices and non-linear equations. The application is further configured for listening for a response for a period of time, after sending a communication to the second device, and then sleeping after the period of time has expired.

In another aspect, a system comprises a communication device and a low power device configured for: implementing a matrix-based authentication communication to communicate with the communication device and sending a plurality of messages to the communication device before performing an additional matrix-based authentication communication. The low power device comprises an Internet of Things device. The low power device further comprises a battery which is charged initially and then is charged using ambient light and/or signals/waves. The low power device is further configured for counting, using a counter on the low power device, to determine when to perform the additional matrix-based authentication communication. The low power device is further configured for utilizing a clock to determine when to perform the next matrix-based key authentication communication. The matrix-based authentication communication utilizes real numbers and white noise. The matrix-based authentication communication utilizes a plurality of matrices and non-linear equations. The low power device is further configured for listening for a response, with the low power device for a period of time, after sending a communication to the communication device, and then sleeping the low power device after the period of time has expired.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a process of secret text transfer using asymmetric keys.

FIG. 2 illustrates a representative process of secret key transfer using cryptography processes according to various embodiments described herein.

FIG. 3A illustrates an example distribution function of variables resulting from the white noise associative cryptography key operations according to various embodiments described herein.

FIG. 3B illustrates example probability distribution functions of variables resulting from the white noise associative cryptography key operations according to various embodiments described herein.

FIG. 4 illustrates example user interfaces of a program to perform cryptography key operations according to various embodiments described herein.

FIG. 5 illustrates a more particular example of a secret key transfer process according to the concepts described herein.

FIG. 6 illustrates an example of a secret key transfer process using authentication according to the concepts described herein.

FIG. 7 illustrates a flowchart of a method of implementing low power encryption in motion according to some embodiments.

FIG. 8 illustrates a flowchart of another method of implementing low power encryption in motion according to some embodiments.

FIG. 9 illustrates a flowchart of a method of implementing low power encryption in motion according to some embodiments.

FIG. 10 illustrates a diagram of a low power device in a communication system according to some embodiments.

FIG. 11 illustrates a diagram of a 1-way data stream encryption according to some embodiments.

FIG. 12 illustrates a flowchart of a method of performing a dynamic key exchange for a moving target according to some embodiments.

FIG. 13 illustrates a diagram of a system for implementing a dynamic key exchange for a moving target according to some embodiments.

FIG. 14 illustrates a flowchart of a method of authentication cryptography operations, exchanges and signatures according to some embodiments.

FIG. 15 illustrates a diagram of an architecture of a system to secure endpoints across various network LAN and WAN infrastructures according to some embodiments.

FIG. 16 illustrates a flowchart of a method of registering endpoints by an authentication server when onboarding to a network according to some embodiments.

FIG. 17 illustrates a flowchart of a method of authentication according to some embodiments.

FIG. 18 illustrates a diagram of an architecture of a system to perform a 3-way key exchange according to some embodiments.

FIG. 19 illustrates a flowchart of a method of system registration according to some embodiments.

FIG. 20 illustrates a diagram of an authentication server and endpoints according to some embodiments.

FIG. 21 illustrates a flowchart of a method of performing endpoint authentication by an endpoint according to some embodiments.

FIG. 22 illustrates a diagram of an accepted connection and a rejected connection according to some embodiments.

FIG. 23 illustrates a flowchart of a method of performing endpoint authentication by an authentication server according to some embodiments.

### DETAILED DESCRIPTION

As noted above, cryptography is related to the study of protocols, techniques, and approaches that prevent third parties from accessing, reading, and/or interpreting secret data. In the context of cryptography, the Rivest-Shamir-Adleman (RSA) cryptosystem, elliptic curve cryptography (ECC) cryptosystem, and other asymmetrical (and symmetrical) methods of secure key exchange have security problems. Those cryptosystems are based on complexity and can, theoretically, be decrypted.

In contrast to the RSA, ECC, and other cryptosystems, the cryptographic processes described herein is more immune to cryptanalysis and permits the sharing of secret data, such as symmetric keys and other secret data, over public networks. The cryptographic system can also be used for authentication. No known methods of traditional or quantum computing can be used to circumvent the cryptographic approaches described herein. The cryptographic system described herein was developed to achieve a number of goals including (1) securely exchanging cryptographic keys over public networks, (2) information ciphering, authentication, and (4) encryption for public networks that is secure against standard and quantum computing.

In the context described herein, white noise can be defined as (or can include) a sequence of independent random variables (e.g., discrete numbers) with a uniform probability distribution. Polynomial white noise can be defined as (or can include) a sequence of polynomial function values composed by independent random variables (e.g., discrete numbers) with a uniform probability distribution.

No known algorithm can decrypt the operations described herein due, at least in part, to the use of white noise randomization. The unknown independent variables appear to third parties as random white noise and, thus, there is no correlation between those variables and any information being transferred. As one example, the key exchange method or process described herein can be shown as an exchange of matrices with a corresponding number of different unknown independent variables and visible values. The number of unknown independent variables always exceeds the number of visible independent values in any combination of subsets of matrices. Further, the number of unknown variables exceeds the number of publically visible polynomial functions. Additionally, no inverse polynomial functions can be determined without information about the secret key—even if the plain text of the secret key is known by a third party.

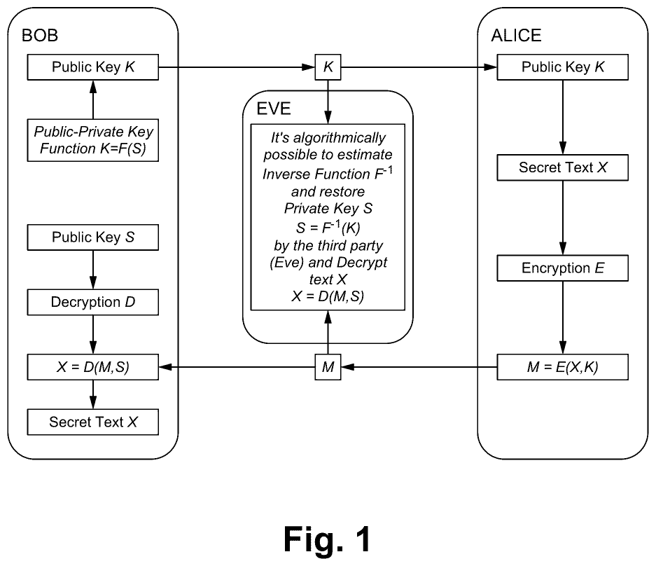

Turning to the drawings, FIG. 1 illustrates a process of secret text transfer using asymmetric keys. In the example shown in FIG. 1, Alice wishes to communicate secret text to Bob over a public network, such as the Internet, and Eve is the eavesdropper. To communicate the secret text, which can be a symmetric key or any other secret information, Alice and Bob use asymmetric cryptography. Asymmetric cryptography relies upon a key pair including a public key that can be disseminated to third parties (e.g., Alice) and a private key which is kept private (e.g., by Bob). In an asymmetric cryptography system, any person can encrypt a message using the public key, and that encrypted message can only be decrypted using the private key. The strength of asymmetric cryptography relies on the degree of difficulty (e.g., computational impracticality) for a private key to be determined from its associated public key. Asymmetric cryptography also depends on keeping the private key private.

Referring back to FIG. 1, Alice obtains a copy of a public key from Bob (or any other source). Alice encrypts the secret text using the public key to produce the encrypted secret text and communicates it to Bob over the public network. Bob then decrypts the encrypted secret text using the private key to obtain the secret key. Over the public network, Eve can only see the encrypted secret text. Even if Eve obtains a copy of the encrypted secret text and the public key used to create it, Eve cannot obtain the secret text from the encrypted secret text using the public key. Instead, only the private key, which is securely held and protected by Bob, can be used to decrypt the encrypted secret text to obtain the secret text from Alice.

There are drawbacks and limitations to using asymmetric cryptography. For example, it is algorithmically possible to estimate (or determine) the private key in a key pair from the publicly available public key. Additionally, asymmetric key pairs are relatively difficult and time consuming to create, typically depending upon the identification of large prime numbers. Further, asymmetric cryptography can be vulnerable in that it may produce the same predictable encrypted output when the same secret text is encrypted.

To be distinguished from other cryptographic systems, various cryptography processes or operations are described herein. In one embodiment, a first cryptographic function is applied to secret data. The first cryptographic function operates as a type of cryptographic key and encrypts or ciphers the secret data to produce a first encrypted result. The first encrypted result can be securely transmitted by a first device to a second device. The second device then applies a second cryptographic function to the first encrypted result. Similar to the first cryptographic function, the second cryptographic function operates as a cryptographic key and further (or doubly) encrypts or ciphers the first encrypted result to produce a second (or doubly) encrypted result. At this point, the secret data has been encrypted by two different cryptographic functions, each of them being sufficient to secure the secret data. The two different cryptographic functions can then be inversed or removed, in any order, to reveal the secret data.

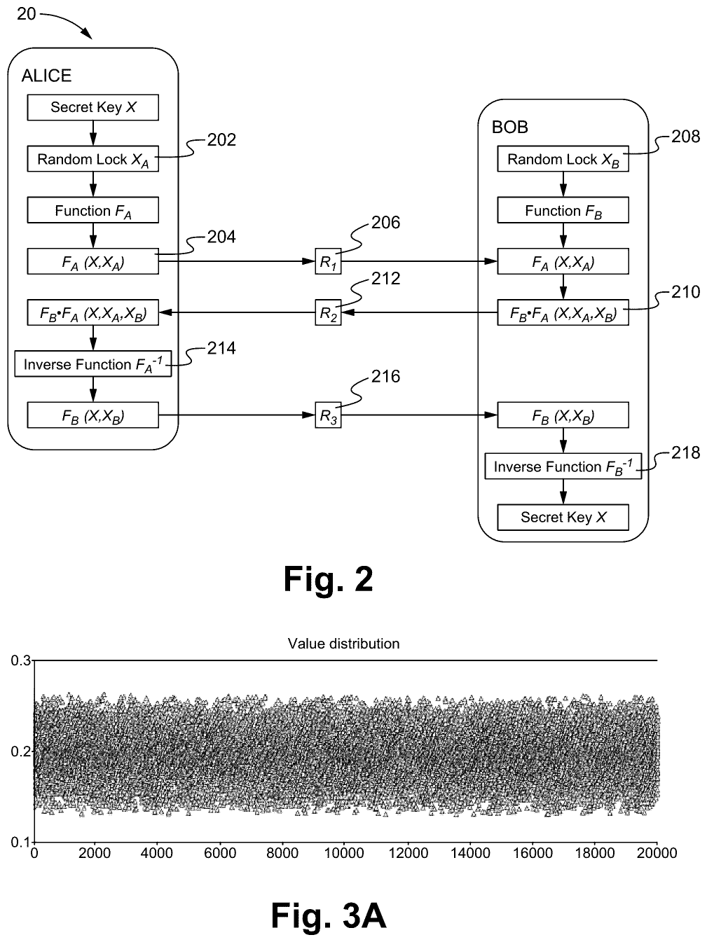

Turning to the embodiments, FIG. 2 illustrates a representative process 20 of secret key transfer using cryptography processes according to various embodiments described herein. The process described below can be performed by any suitable computing device(s) including a processor and memory, without limitation. In the example shown in FIG. 2, Alice wants to securely pass the secret key X to Bob over a public network. To do so, Alice should first encrypt the secret keyXbefore sending it to Bob.

To encrypt the secret key X, Alice holds a first cryptographic function F_{A}. In various embodiments, the cryptographic function F_{A} can be embodied as any suitable mathematical function having an inverse which cannot be determined without knowledge of a certain set of parameters of the mathematical function. In one embodiment, the function F_{A} can be embodied as a polynomial function or multivariate polynomial function defined in part by one or more variables, combinations of variables, combinations of variables at various powers, and coefficients. To undo or unlock (e.g., decrypt) the effect of the cryptographic function F_{A}, Alice also holds a first inverse cryptographic function F⁻¹A.

To start, at step 202, the process 20 includes Alice generating, with a first computing device, a first random lock X_{A}. The first random lock X_{A} can be embodied as an array or vector of random scalar integers, for example, or another suitable organized structure of random numbers. In the process 20, the first random lock X_{A} can operate as a type of initialization vector upon which the cryptographic function F_{A} is applied in combination with the secret key X For example, the first random lock X_{A} helps to randomize the application of the cryptographic function F_{A} creating, in effect, a new random cryptographic function F_{A} for each different random lock X_{A}. In that context, the first random lock X₄ helps to achieve semantic security, so that repeated usage of the cryptographic function F_{A} with the same operand does not produce the same ciphered result and does not allow an attacker to infer any information.

At step 204, the process 20 includes Alice applying, with the first computing device, the first cryptographic function F_{A} to a combination of the secret key X and the first random lock X_{A} to produce a first encrypted result R₁. Here, Alice's secret key X, which can include letters, numbers, American Standard Code for Information Interchange (ASCII) characters, etc., is ciphered with random numbers (i.e., the first random lock X_{A}) using the cryptographic operation or function F_{A}. The cryptographic function F_{A} can be embodied as any suitable mathematical function, such as a polynomial or multivariate polynomial function. For example, the cryptographic function F_{A} can be embodied as a polynomial function F(CX*) of kth order written as:

$$F ( C {X}^{k} ) = {{\sum }_{{i}_{1} = 1}}^{k} … {\sum }_{{i}_{k} = 1}^{k} {C}_{{i}_{1} {i}_{2}} {…}_{{i}_{k}} {X}_{{i}_{1}} {X}_{{i}_{2}} … {X}_{{i}_{k}} , \qquad ( 1 )$$

where C_{i . . . k} are coefficients of the polynomial function F(CX*), and X_{i . . . k} are combinations of the operand X, which can include a combination of a random lock and secret data.

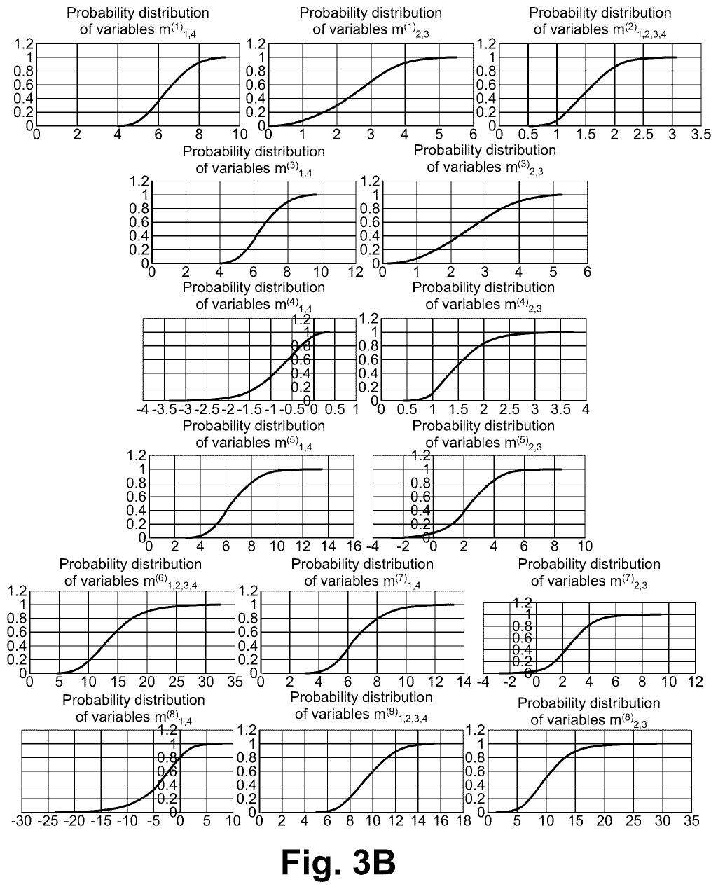

Thus, at step 204, Alice's secret key X, which may include letters, numbers, American Standard Code for Information Interchange (ASCII) characters, etc., are ciphered with random numbers based on the first random lock X_{A} and the first cryptographic function F_{A}. As an example, a distribution function of the variables in the results R₁, R₂, and R₃ is shown in FIG. 3A, and probability distribution functions of the variables in the results R₁, R₂, and R₃ is shown in FIG. 3B.

The structure of the polynomial function F(CX^{k}) and the coefficients can be known to others (although they generally are not) from the formalization of the algorithm. However, even if the structure of the polynomial function F and values of the coefficients C, k are known to a third party, the third party still cannot decrypt the transferred information.

At step 206, the process 20 includes Alice transmitting, with the first computing device, the first encrypted result R₁ to Bob's second computing device. At step 208, the process 20 includes Bob generating, with the second computing device, a second random lock X_{B}. Similar to the first random lock X_{A}, the second random lock X_{B} can be embodied as an array or vector of random scalar integers, for example, or another suitable organized structure of random numbers. In the process 20, the second random lock Xs can also operate as a type of initialization vector for the cryptographic function F_{B}. For example, the second random lock X_{B} helps to randomize the application of Bob's cryptographic function F_{B} creating, in effect, a new random cryptographic function F_{B} for each different random lock _{XB}. In that context, the second random lock X_{B} helps to achieve semantic security, so that repeated usage of the cryptographic function F_{B} with the same operand does not produce the same ciphered result and does not allow an attacker to infer any information.

At step 210, the process includes Bob applying, with the second computing device, Bob's cryptographic function F_{B} to a combination of the first encrypted result R₁ and the second random lock X_{B} to produce a second encrypted result R₂. Here, the first encrypted result R₁ (e.g., F_{A}(X,X_{A})) is (doubly) ciphered with random numbers (i.e., the second random lock X_{B}) using the cryptographic operation or function F_{B}. The cryptographic function F_{B} can be embodied as any suitable mathematical function, such as a polynomial or multivariate polynomial function. For example, the cryptographic function F_{B} can be embodied as a polynomial function F(CX^{k}) of kth order according to that shown above in Equation (1).

At this point, Alice's secret key X has been encrypted or ciphered by two different cryptographic functions F_{A} and F_{B}, each of them being sufficient to secure the secret key X from others. The two different cryptographic functions can then be inversed or removed, in any order, to reveal the secret key X In other words, to decrypt the secret key X from the second encrypted result R₂ (i.e., to undo the effects of the cryptographic functions F_{A} and Fa) it is possible to either apply the inverse F⁻¹_{A} function to F_{A} or the inverse F⁻¹_{B} function to F_{B} first. Thus, according to one aspect of associative cryptography key operations described herein, the order in which the second encrypted result R₂ is applied to the inverse cryptographic functions F⁻¹_{A} and F⁻¹_{B}. does not impact the results of the decryption of secret key X from the second encrypted result R₂. Further, any number of cryptographic functions to F₁ . . . F_{N} can be applied to encrypt secret data in any order to produce an encrypted result RN, and that encrypted result RN can be decrypted in any order using the inverse cryptographic functions F⁻¹_{N} . . . F⁻¹_{N}.

At step 212, the process 20 includes Bob transmitting, with the second computing device, the second encrypted result R₂ to the first computing device. At step 214, the process 20 includes Alice applying, with the first computing device, the first inverse cryptographic function F⁻¹_{A} to the second encrypted result R₂ to produce the result R₃. The first inverse cryptographic function F⁻¹_{A} unlocks or removes the effect of both the first random lock X_{A} and the first cryptographic function F_{A}. Thus, the result R₃ is what remains of the second encrypted result R₂ after the effect of the first random lock X, and the first cryptographic function F_{A} are undone or unlocked (e.g., F_{B}(X,X_{B})). Thus the result R₃ is still encrypted, but only by Bob's second random lock X_{B} and the second cryptographic function F_{B}, and the result R₃ can be securely transmitted over the public network.

At step 216, the process 20 includes Alice transmitting, with the first computing device, the result R₃ to the second computing device. Finally, at step 218, the process 20 includes Bob applying, with the second computing device, the second inverse cryptographic function F⁻¹_{B} to the result R₃ to arrive at the secret key X.

At the end of the process 20, the secret key X has been securely communicated from Alice to Bob. In contrast to the asymmetric key process described above with reference to FIG. 1, key pairs are not used in the process 20.

The general idea embodied in the process 20 is based on certain features of the publically unknown vectors X and the publically available (potentially visible) vectors R. Particularly, the number of variables “n” of the vectors X{x₁, . . . , xₙ} is always more than the number of variables “m” of the vectors R={r₁, . . . , rₘ}, i.e., n>m. Thus, there are no known algorithms which give a definite decryption solution of the secret key X, based only on visible values of the vectors R in the public networks. From this point of view, the method is cryptanalysis resistant. To obtain the only solution x₁, . . . , xₙ from the values r₁, . . . , rₘ of the polynomial functions F_{A} and F_{B}, the third party (e.g., outsider Eve) should have additional information about the structure of the random vectors X_{A} and X_{B}, which are available for Alice and Bob only. For instance, from x₁+x₂+x₃=r₁, it is not possible for a third party to arrive at a single solution for x, with only the value of the variable r₁ being publically visible, because the additional information about the values of the variables x₂+x₃ are not known.

A comparison of the features of asymmetrical methods and the method described herein is give in Table 1 below.

TABLE 1

| | Public-Private Key | |
|---|---|---|
| | Asymmetrical | PWN Three |
| Features | (RSA, ECC) | Pass Method |
| Numbers | Prime Numbers | Any Random |
| | | Numbers |
| Time to Develop New | Relatively More Costly | Negligible |
| Key | | |
| Processing Time | Relatively More Costly | Negligible |
| Inverse Function From | Relatively Complex | Inverse Function |
| Public Key | | Does Not Exist |
| Third Party Defeat | Possible | Never |
| Public Network Output | Constant, predictable | Random, |
| For Constant Input | | unpredictable |

An example of the use of the method described herein is provided below. Using the method, plain text (as a letter or ASCII code of 256 numbers) is represented in ciphered text by three corresponding random numbers r₁, r₂ and r₃ which are calculated by a random generator. Table 2 shows an example of how the plain text “This is a plain text” appears in ciphered numbers.

TABLE 2

| Plain | | | |
|---|---|---|---|
| text | Ciphered text | | |
| text | r₁ | r₂ | r₃ |
| T | 0.001251 | 0.563585 | 0.003585 |
| h | 0.193304 | 0.808741 | 0.158307 |
| i | 0.585009 | 0.479873 | 0.28051 |
| s | 0.350291 | 0.895962 | 0.313555 |
| | 0.82284 | 0.746605 | 0.614412 |
| i | 0.174108 | 0.858943 | 0.151801 |
| s | 0.710501 | 0.513535 | 0.363394 |
| | 0.303995 | 0.014985 | 0.006167 |
| a | 0.091403 | 0.364452 | 0.035009 |
| | 0.147313 | 0.165899 | 0.02575 |
| p | 0.988525 | 0.445692 | 0.438709 |
| 1 | 0.119083 | 0.004669 | 0.001204 i |
| a | 0.00891 1 | 0.37788 | 0.005292 |
| i | 0.531663 | 0.571184 | 0.303183 |
| n | 0.601764 | 0.607166 | 0.363988 |
| | 0.166234 | 0.663045 | 0.113037 |
| t | 0.450789 | 0.352123 | 0.159469 |
| e | 0.057039 | 0.607685 | 0.037377 |
| x | 0.783319 | 0.802606 | 0.623152 |
| t | 0.519883 | 0.30195 | 0.157851 |

Uniform distribution is called “white noise” due to its informative features. For the letter ‘A’ (ASCII code 65), as one example, the random numbers may appear over the public net as r₁=0.001251, r₂=0.563585, r₃=0.560746 or r₁=0.585009, r₂=0.479873, r₃=0.105796 and every time the random variables r₁, r₂, r₃ will be unpredictable. The correlation function between any two variables x and y is estimated as follows:

$$corr ( x , y ) = \frac{\sum ( x - \overline{x} ) ( y - \overline{y} )}{\sqrt{\sum {( x - \overline{x} )}^{2} \sum {( y - \overline{y} )}^{2}}} . \qquad ( 2 )$$

The results of correlation function evaluation for pairs (r₁, r₂), (r₂, r₃) and (r₁, r₃) are given in Table 3 below.

TABLE 3

| corr (r₁, r₂) | corr (r₂, r₃) | corr (r₁, r₃) |
|---|---|---|
| −0.013927 | −0.002873 | −0.010771 |

The correlation is negligibly small, which means that ciphered information is encapsulated into white noise and is not analyzable by a third party. There are no known algorithms to decrypt the ciphered information without the encryption key.

In the approaches described herein, there are neither restrictions nor requirements on the encryption key number and length. All keys are equal in terms of crypt analysis resistance. Additionally, there are no correlations between the plain text and the ciphered random numbers (r₁, r₂, r₂), as the combinations of them are unpredictable. There are no known algorithms which can decrypt ciphered random numbers (r₁, r₂, r₃) into plain text without the key. There are no known algorithms which can recalculate the encryption key using visible ciphered random numbers (r₁, r₂, r₃) and visible plain text. There is no need for rotation of encryption keys if a physical, completely unpredictable random number generator is used. The series repetition period of real random numbers (r₁, r₂, r₃) is infinite.

Computational time needed to encrypt and decrypt data by the method described herein is significantly smaller than commonly used algorithms. Since the method uses polynomial functions, the transaction of numbers (or ASCII) should be controlled by calculation procedures. The analysis of 25,600,000 transactions demonstrates that the final error of the secret key value estimate does not exceed 0.0010%. This means that, for example, the transaction of the letter ‘A,’ which is represented by the integer number 65 (ASCII), after all transformations from client to server could be calculated to be a number about 64.9999 (and depends in part on the random generator variables during the transaction). A comparison of the features of a standard symmetrical method and the method described herein are given in Table 4 below.

TABLE 4

| | | WNT One Pass Transaction |
|---|---|---|
| | Symmetrical | (in combination with Three |
| Features | FIPS Pub 197 | Pass Transaction) |
| Encryption Key Rotation | Must Have | Not Needed |
| Processing time | Costly | Negligible |
| Security resistance and key | Strong relation | No Relation |
| length | | |
| Hack | Costly | Never (Potentially |
| | | Impossible) |
| Public net output for | Constant, | Random, Unpredictable |
| constant input (without key | Predictable | |
| rotation) | | |

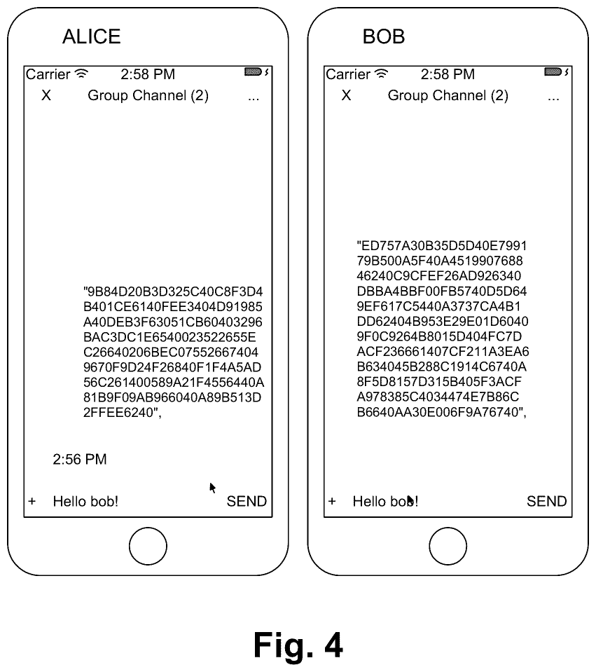

A computer program was developed to implement the method described herein. As shown in FIG. 4, Alice securely sends her secret text “Hello bob” to Bob using the three pass transaction. In FIG. 4, random values appear to a third party during the three pass transaction (specially shown in the blue box).

Among other benefits, the processes described herein can be used to achieve unbreakable (or nearly unbreakable) encryption over wireless, wired, and public networks, and against quantum computing attacks. It requires relatively little processing power for encrypting and decrypting and, thus, can be used for rapid verification and transactions. A practically limitless number of new keys can be generated on the fly. Thus, the keys can be changed on every transaction. Encryption and decryption can also occur on individual devices due to the high speed of encryption and low processing requirements. Further, there is no single point of compromise because every individual party has their own key. If a key is compromised, it is the one compromised and can be renewed or replaced.

An outline of various problems encountered and solutions that can be provided by the cryptographic systems described herein are given in Table 5 below.

TABLE 5

| Problem | Solution |
|---|---|
| Establishing a secure and | Digital ID system in the cloud |
| reliable ID for all transactions | for processing Ids |
| | ID system only used for |
| | registration and verification |
| | Information unhackable |
| Having a secure payment | Payment system using ID |
| system that eliminates fraud | Email, internet banking, wireless |
| | transaction |
| Cryptocurrency that is secure | Absolutely secure, stable, and |
| and stable | based on verifiable IDs |
| Fast enough and secure trading | Rapid trading and verification |
| system for cryptocurrencies | Trading exchanges connected to |
| | Exchange |
| Mobile Payments | Integrity over wireless signals |
| | and public net |
| | Transactions cannot be defrauded |
| | via screening or copying |
| Key Management System | Cloud key management service |
| | ID system to outsource all key |
| | management responsibilities |
| People forget passwords and | Pass eliminates the use of |
| passwords are a weak point | passwords using ID center |
| in security | |

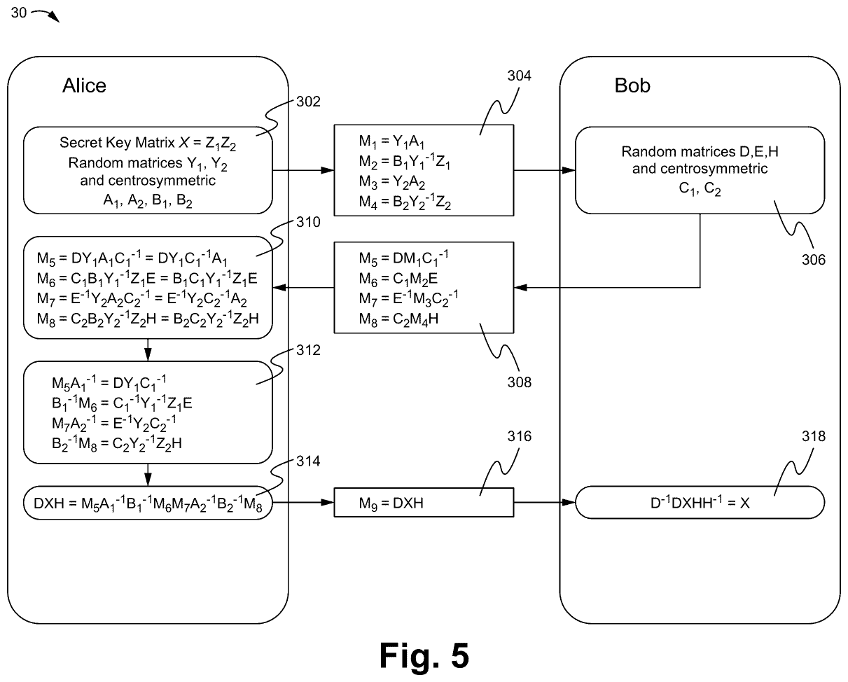

FIG. 5 illustrates a more particular example of a secret key transfer process 30 according to the concepts described herein. While an example using square matrices of a certain size is provided below, the concepts described herein can be extended to use with square matrices of any size. Further, although the example below is presented in certain cases as steps between “Alice” and “Bob,” the process is conducted by computing systems or devices.

At the outset, consider the key to be exchanged, K, as a sequence of m bytes, each including one of the ASCII codes from 0 to 255, as follows:

K={k₁,k₂, . . . ,kₘ}, 0≤kᵢ≤255.

For example, the key string “ABCD” can be presented as ASCII codes K={65, 66, 67, 68}. A sequence of real numbers X can then be defined as a transformation of the key numbers (i.e., k₁, k₂, kₘ), which are integers, into real ones, as follows:

X=Φ(K),Φ:Nₘ→R^{m} and

X={x₁,x₂, . . . ,xₘ}, xᵢ∈R.

The sequence of real numbers is put into set of second order square matrices, as

$$X = \vert \begin{matrix}{x}_{1} & {x}_{2} \\ {x}_{3} & {x}_{4}\end{matrix} \vert … \vert \begin{matrix}{x}_{m - 3} & {x}_{m - 2} \\ {x}_{m - 1} & {x}_{m}\end{matrix} \vert$$

If the number of real key numbers is not multiple of four, the last matrix is not fully filled in. In this case, the rest of the matrix members can be generated and added as any random numbers without influencing the algorithm.

Now, assume that Alice wants to pass the secret key K to Bob. For simplicity, however, consider one square matrix X, as follows:

$$X = \vert \begin{matrix}{x}_{1} & {x}_{2} \\ {x}_{3} & {x}_{4}\end{matrix} \vert$$

The matrix X decomposes into two singular matrices Z₁ and Z₂

$$X = {Z}_{1} , {Z}_{2} , \\ {Z}_{1} = \vert \begin{matrix}{z}_{1} & {z}_{2} \\ {z}_{3} & \frac{{z}_{2} {z}_{3}}{{z}_{1}}\end{matrix} \vert , and \\ {Z}_{2} = \vert \begin{matrix}{z}_{4} & {z}_{5} \\ {z}_{6} & \frac{{z}_{4} {z}_{5}}{{z}_{6}}\end{matrix} \vert$$

At step 302, the process includes forming the matrix X as a singular matrix using a number of the real key numbers of the secret key K based on the following relationship x₄=x₂x₃/x₁. In that case, the inverse of matrix X, or X⁻¹, does not exist (see properties of singular matrices and matrix determinants in APPENDIX). In that case, the matrix X represents a portion of the secret key K,{k₁, k₂, k₃}.

As part of a first pass transaction, at step 302, the process further includes generating a uniformly distributed random matrices Y₁, Y₂ and inverse matrices Y₁⁻¹, Y₂⁻¹, as follows:

$${Y}_{1} = \vert \begin{matrix}{y}_{1} & {y}_{2} \\ {y}_{3} & {y}_{4}\end{matrix} \vert , \\ {Y}_{1}^{- 1} = \frac{\vert \begin{matrix}{y}_{4} & - {y}_{2} \\ - {y}_{3} & {y}_{1}\end{matrix} \vert}{{y}_{1} {y}_{4} - {y}_{2} {y}_{3}} , {y}_{i} ∈ R , {y}_{1} {y}_{4} \neq {y}_{2} {y}_{3} , \\ {Y}_{2} = \vert \begin{matrix}{y}_{5} & {y}_{6} \\ {y}_{7} & {y}_{8}\end{matrix} \vert , and \\ {Y}_{2}^{- 1} = \frac{\vert \begin{matrix}{y}_{8} & - {y}_{6} \\ - {y}_{7} & {y}_{5}\end{matrix} \vert}{{y}_{5} {y}_{8} - {y}_{6} {y}_{7}} , {y}_{i} ∈ R , {y}_{5} {y}_{8} \neq {y}_{6} {y}_{7} .$$

At step 302, the process also includes generating uniformly distributed random centrosymmetric A₁, A₂, B₁, B₂, and inverse A₁⁻¹, A₂⁻¹, B₁⁻¹, B₂⁻¹ matrices as follows:

$${A}_{1} = \vert \begin{matrix}{a}_{1} & {a}_{2} \\ {a}_{2} & {a}_{1}\end{matrix} \vert , \\ {A}_{2} = \vert \begin{matrix}{a}_{3} & {a}_{4} \\ {a}_{4} & {a}_{3}\end{matrix} \vert , \\ {A}_{1}^{- 1} = \frac{\vert \begin{matrix}{a}_{1} & - {a}_{2} \\ - {a}_{2} & {a}_{1}\end{matrix} \vert}{{a}_{1}^{2} - {a}_{2}^{2}} , \\ {A}_{2}^{- 1} = \frac{\vert \begin{matrix}{a}_{3} & {a}_{4} \\ {a}_{4} & {a}_{3}\end{matrix} \vert}{{a}_{3}^{2} - {a}_{4}^{2}} , {a}_{i} ∈ R , {a}_{1}^{2} \neq {a}_{2}^{2} , {a}_{3}^{2} \neq {a}_{4}^{2} , \\ {B}_{1} = \vert \begin{matrix}{b}_{1} & {b}_{2} \\ {b}_{2} & {b}_{1}\end{matrix} \vert , \\ {B}_{2} = \vert \begin{matrix}{b}_{3} & {b}_{4} \\ {b}_{4} & {b}_{3}\end{matrix} \vert , \\ {B}_{1}^{- 1} = \frac{\vert \begin{matrix}{b}_{1} & - {b}_{2} \\ - {b}_{2} & {b}_{1}\end{matrix} \vert}{{b}_{1}^{2} - {b}_{2}^{2}} , \\ {B}_{2}^{- 1} = \vert \begin{matrix}{b}_{3} & - {b}_{4} \\ - {b}_{4} & {b}_{3}\end{matrix} \vert , {b}_{i} ∈ R , {b}_{1}^{2} \neq {b}_{2}^{2} , {b}_{3}^{2} \neq {b}_{4}^{2} .$$

Centrosymmetric square matrices A and B are always of the form AB=BA.

At step 304, the process includes Alice generating and sending matrices M₁ and M₂ to Bob, as follows:

$${M}_{1} = \vert \begin{matrix}{m}_{1}^{( 1 )} & {m}_{2}^{( 1 )} \\ {m}_{3}^{( 1 )} & {m}_{4}^{( 1 )}\end{matrix} \vert , \\ {M}_{2} = \vert \begin{matrix}{m}_{1}^{( 2 )} & {m}_{2}^{( 2 )} \\ {m}_{3}^{( 2 )} & {m}_{4}^{( 2 )}\end{matrix} \vert , \\ {M}_{3} = \vert \begin{matrix}{m}_{1}^{( 3 )} & {m}_{2}^{( 3 )} \\ {m}_{3}^{( 3 )} & {m}_{4}^{( 3 )}\end{matrix} \vert , \\ {M}_{4} = \vert \begin{matrix}{m}_{1}^{( 4 )} & {m}_{2}^{( 4 )} \\ {m}_{3}^{( 4 )} & {m}_{4}^{( 4 )}\end{matrix} \vert .$$

which are generated according to the following calculations:

M₁=Y₁A₁ (3)

M₂=B₁Y₁⁻¹Z₁, (4)

M₃=Y₁A₂, and (5)

M₄=B₂Y₂⁻¹Z₂, (6)

Thus, at step 304, Alice sends to Bob fourteen publicly visible values (m₁⁽¹⁾, m₂⁽¹⁾, m₃⁽¹⁾, m₄⁽¹⁾, m₁⁽²⁾, m₂⁽²⁾, m₃⁽²⁾, m₁⁽³⁾, m₂⁽³⁾, m₃⁽³⁾, m₄⁽³⁾, m₁⁽⁴⁾, m₂⁽⁴⁾, m₃⁽⁴⁾) of matrices M₁, M₂, M₃ and M₄ that are calculated from twenty-two independent unknown (for the third party) variables (a₁, a₂, a₃, a₄, b₁, b₂, b₃, b₄, y₁, y₂, y₃, y₄, y₅, y₆, y₇, y₈, z₁, z₂, z₃, z₄, z₅, z₆) known by Alice only, as follows:

$${m}_{1}^{( 1 )} = {a}_{1} {y}_{1} + {a}_{2} {y}_{2} , \\ {m}_{2}^{( 1 )} = {a}_{2} {y}_{1} + {a}_{1} {y}_{2} , \\ {m}_{3}^{( 1 )} = {a}_{1} {y}_{3} + {a}_{2} {y}_{4} , \\ {m}_{4}^{( 1 )} = {a}_{2} {y}_{3} + {a}_{1} {y}_{4} , \\ {m}_{1}^{( 2 )} = \frac{{b}_{1} ( {x}_{1} {y}_{4} - {x}_{3} {y}_{2} ) + {b}_{2} ( {x}_{3} {y}_{1} - {x}_{1} {y}_{3} )}{{y}_{1} {y}_{4} - {y}_{2} {y}_{3}} , \\ {m}_{2}^{( 2 )} = \frac{{b}_{1} ( {x}_{2} {y}_{4} - {y}_{2} {x}_{2} {x}_{3} / {x}_{1} ) + {b}_{2} ( {y}_{1} {x}_{2} {x}_{3} - {x}_{2} {y}_{3} )}{{y}_{1} {y}_{4} - {y}_{2} {y}_{3}} , \\ {m}_{3}^{( 2 )} = \frac{{b}_{2} ( {x}_{1} {y}_{4} - {x}_{3} {y}_{2} ) + {b}_{1} ( {x}_{3} {y}_{1} - {x}_{1} {y}_{3} )}{{y}_{1} {y}_{4} - {y}_{2} {y}_{3}} \\ {m}_{1}^{( 3 )} = {a}_{3} {y}_{5} + {a}_{4} {y}_{6} , \\ {m}_{2}^{( 3 )} = {a}_{4} {y}_{5} + {a}_{3} {y}_{6} , \\ {m}_{3}^{( 3 )} = {a}_{3} {y}_{7} + {a}_{4} {y}_{8} , \\ {m}_{4}^{( 3 )} = {a}_{4} {y}_{7} + {a}_{3} {y}_{8} , \\ {m}_{1}^{( 4 )} = \frac{{b}_{3} ( {x}_{4} {y}_{8} - {x}_{6} {y}_{6} ) + {b}_{4} ( {x}_{6} {y}_{5} - {x}_{4} {y}_{7} )}{{y}_{5} {y}_{4} - {y}_{6} {y}_{3}} , \\ {m}_{2}^{( 4 )} = \frac{{b}_{3} ( {x}_{5} {y}_{8} - {y}_{6} \frac{{x}_{5} {y}_{6}}{{x}_{4}} ) + {b}_{4} ( {y}_{5} \frac{{x}_{5} {y}_{6}}{{x}_{4}} - {x}_{5} {y}_{7} )}{{y}_{5} {y}_{8} - {y}_{6} {y}_{7}} , \\ {m}_{3}^{( 4 )} = \frac{{b}_{4} ( {x}_{4} {y}_{8} - {x}_{6} {y}_{6} ) + {b}_{3} ( {x}_{6} {y}_{5} - {x}_{4} {y}_{7} )}{{y}_{5} {y}_{8} - {y}_{6} {y}_{7}} .$$

The variable m₄⁽²⁾ and m₄⁽⁴⁾ of the singular matrices M₂ and M₂ are used as m₄⁽²⁾=m₂⁽²⁾m₃⁽²⁾/m₁⁽²⁾ and m₄⁽²⁾=m₂⁽²⁾m₃⁽²⁾/m₁⁽²⁾.

As a second pass transaction, at step 306, the process includes Bob receiving the M₁ and M₂ matrices from Alice. At step 306, the process includes generating uniformly distributed random centrosymmetric matrices C₁, C₂ and inverse C₁⁻¹, C₂⁻¹) matrices, as follows:

$${C}_{1} = \vert \begin{matrix}{c}_{1} & {c}_{2} \\ {c}_{2} & {c}_{1}\end{matrix} \vert , \\ {C}_{2} = \vert \begin{matrix}{c}_{3} & {c}_{4} \\ {c}_{4} & {c}_{3}\end{matrix} \vert , \\ {C}_{1}^{- 1} = \frac{\vert \begin{matrix}{c}_{1} & - {c}_{2} \\ - {c}_{2} & {c}_{1}\end{matrix} \vert}{{c}_{1}^{2} - {c}_{2}^{2}} , {c}_{i} ∈ R , {c}_{1}^{2} \neq {c}_{2}^{2} , and \\ {C}_{2}^{- 1} = \frac{\vert \begin{matrix}{c}_{3} & - {c}_{4} \\ - {c}_{4} & {c}_{3}\end{matrix} \vert ,}{{c}_{3}^{2} - {c}_{4}^{2}} , {c}_{i} ∈ R , {c}_{3}^{2} \neq {c}_{4}^{2} .$$

The process at step 306 also includes generating uniformly distributed random matrices D and H, as follows:

$$D = \vert \begin{matrix}{d}_{1} & {d}_{2} \\ {d}_{3} & {d}_{4}\end{matrix} \vert , and \\ H = \vert \begin{matrix}{h}_{1} & {h}_{2} \\ {h}_{3} & {h}_{4}\end{matrix} \vert , {d}_{i} , {h}_{i} ∈ R , {d}_{1} , {d}_{4} \neq {d}_{2} {d}_{3} , {h}_{1} , {h}_{4} \neq {h}_{2} {h}_{3} .$$

The process at step 306 also includes generating corresponding inverse matrices D⁻¹ and H⁻¹, as follows:

$${D}^{- 1} = \frac{\vert \begin{matrix}{d}_{1} & {d}_{2} \\ {d}_{3} & {d}_{4}\end{matrix} \vert}{{d}_{1} {d}_{4} - {d}_{2} {d}_{3}} , and \\ {H}^{- 1} = \frac{\vert \begin{matrix}{h}_{1} & {h}_{2} \\ {h}_{3} & {h}_{4}\end{matrix} \vert}{{h}_{1} {h}_{4} - {h}_{2} {h}_{3}} .$$

The process at step 306 also includes generating the matrices M₅, M₆, M₇ and M₈, as follows:

$${M}_{5} = \vert \begin{matrix}{m}_{1}^{( 5 )} & {m}_{2}^{( 5 )} \\ {m}_{3}^{( 5 )} & {m}_{4}^{( 5 )}\end{matrix} \vert , \\ {M}_{6} = \vert \begin{matrix}{m}_{1}^{( 6 )} & {m}_{2}^{( 6 )} \\ {m}_{3}^{( 6 )} & {m}_{4}^{( 6 )}\end{matrix} \vert , \\ {M}_{7} = \vert \begin{matrix}{m}_{1}^{( 7 )} & {m}_{2}^{( 7 )} \\ {m}_{3}^{( 7 )} & {m}_{4}^{( 7 )}\end{matrix} \vert , \\ {M}_{8} = \vert \begin{matrix}{m}_{1}^{( 8 )} & {m}_{2}^{( 8 )} \\ {m}_{3}^{( 8 )} & {m}_{4}^{( 8 )}\end{matrix} \vert ,$$

as a result of the following calculations:

M₅=DM₁C⁻¹=D₁Y₁A₁C⁻¹, (7)

M₆=C₁M₂E=C₁B₁Y₁⁻¹Z₁E, (8)

M₇=E⁻¹M₃C₂⁻¹=E⁻¹YA₂C₂⁻¹, and (9)

M₈=C₂M₄H=C₂B₂Y₂⁻¹Z₂H. (10)

At step 308, the process includes Bob sending to Alice fourteen publicly visible values (m₁⁽⁵⁾, m₂⁽⁵⁾, m₃⁽⁵⁾, m₄⁽⁵⁾, m₁⁽⁶⁾, m₂⁽⁶⁾, m₃⁽⁶⁾, m₁⁽⁷⁾, m₂⁽⁷⁾, m₃⁽⁷⁾, m₄⁽⁷⁾, m₁⁽⁸⁾, m₂⁽⁸⁾, m₃⁽⁸⁾) of matrices M₃ and M₄ that are calculated from sixteen independent unknown (for the third party) variables (c₁, c₂, c₃, c₄, d₁, d₂, d₃, d₄, e₁, e₂, e₃, e₄, h₁, h₂, h₃, h₄) which are known by Bob only, as follows:

$${m}_{1}^{( 5 )} = \frac{{c}_{1} ( {d}_{1} {m}_{1}^{( 1 )} + {d}_{2} {m}_{3}^{( 1 )} ) - {c}_{2} ( {d}_{1} {m}_{2}^{( 1 )} + {d}_{2} {m}_{4}^{( 1 )} )}{{c}_{1}^{2} - {c}_{2}^{2}} , \\ {m}_{2}^{( 5 )} = \frac{{c}_{1} ( {d}_{1} {m}_{2}^{( 1 )} + {d}_{2} {m}_{4}^{( 1 )} ) - {c}_{2} ( {d}_{1} {m}_{1}^{( 1 )} + {d}_{2} {m}_{3}^{( 1 )} )}{{c}_{1}^{2} - {c}_{2}^{2}} , \\ {m}_{3}^{( 5 )} = \frac{{c}_{1} ( {d}_{3} {m}_{1}^{( 1 )} + {d}_{4} {m}_{3}^{( 1 )} ) - {c}_{2} ( {d}_{3} {m}_{2}^{( 1 )} + {d}_{4} {m}_{4}^{( 1 )} )}{{c}_{1}^{2} - {c}_{2}^{2}} , \\ {m}_{4}^{( 5 )} = \frac{{c}_{1} ( {d}_{3} {m}_{2}^{( 1 )} + {d}_{4} {m}_{4}^{( 1 )} ) - {c}_{2} ( {d}_{3} {m}_{1}^{( 1 )} + {d}_{4} {m}_{3}^{( 1 )} )}{{c}_{1}^{2} - {c}_{2}^{2}} , \\ {m}_{1}^{( 6 )} = ( {c}_{1} {m}_{1}^{( 2 )} + {c}_{2} {m}_{3}^{( 2 )} ) {e}_{1} + ( {c}_{1} {m}_{2}^{( 2 )} + {c}_{2} {m}_{4}^{( 2 )} ) {e}_{3} , \\ {m}_{2}^{( 6 )} = ( {c}_{1} {m}_{1}^{( 2 )} + {c}_{2} {m}_{3}^{( 2 )} ) {e}_{2} + ( {c}_{1} {m}_{2}^{( 2 )} + {c}_{2} {m}_{4}^{( 2 )} ) {e}_{4} , \\ {m}_{3}^{( 6 )} = ( {c}_{2} {m}_{1}^{( 2 )} + {c}_{1} {m}_{3}^{( 2 )} ) {e}_{1} + ( {c}_{2} {m}_{2}^{( 2 )} + {c}_{1} {m}_{4}^{( 2 )} ) {e}_{3} , \\ {m}_{4}^{( 6 )} = {m}_{2}^{( 6 )} {m}_{3}^{( 6 )} / {m}_{1}^{( 6 )} , \\ {m}_{1}^{( 7 )} = \frac{{c}_{3} ( {e}_{4} {m}_{1}^{( 3 )} - {e}_{2} {m}_{3}^{( 3 )} ) - {c}_{4} ( {e}_{4} {m}_{2}^{( 3 )} - {e}_{2} {m}_{4}^{( 3 )} )}{( {c}_{3}^{2} - {c}_{4}^{2} ) ( {e}_{1} {e}_{4} - {e}_{2} {e}_{3} )} , \\ {m}_{2}^{( 7 )} = \frac{{c}_{3} ( {e}_{4} {m}_{2}^{( 3 )} - {e}_{2} {m}_{4}^{( 3 )} ) - {c}_{4} ( {e}_{4} {m}_{1}^{( 3 )} - {e}_{2} {m}_{3}^{( 3 )} )}{( {c}_{3}^{2} - {c}_{4}^{2} ) ( {e}_{1} {e}_{4} - {e}_{2} {e}_{3} )} , \\ {m}_{3}^{( 7 )} = \frac{{c}_{3} ( {e}_{1} {m}_{3}^{( 3 )} - {e}_{3} {m}_{1}^{( 3 )} ) - {c}_{4} ( {e}_{1} {m}_{4}^{( 3 )} - {e}_{3} {m}_{2}^{( 3 )} )}{( {c}_{3}^{2} - {c}_{4}^{2} ) ( {e}_{1} {e}_{4} - {e}_{2} {e}_{3} )} , \\ {m}_{4}^{( 7 )} = \frac{{c}_{3} ( {e}_{1} {m}_{4}^{( 3 )} - {e}_{3} {m}_{2}^{( 3 )} ) - {c}_{4} ( {e}_{1} {m}_{3}^{( 3 )} - {e}_{3} {m}_{1}^{( 3 )} )}{( {c}_{3}^{2} - {c}_{4}^{2} ) ( {e}_{1} {e}_{4} - {e}_{2} {e}_{3} )} , \\ {m}_{1}^{( 8 )} = ( {c}_{3} {m}_{1}^{( 4 )} + {c}_{4} {m}_{3}^{( 4 )} ) {h}_{1} + ( {c}_{3} {m}_{2}^{( 4 )} + {c}_{4} {m}_{4}^{( 4 )} ) {h}_{3} , \\ {m}_{2}^{( 8 )} = ( {c}_{3} {m}_{1}^{( 4 )} + {c}_{4} {m}_{3}^{( 4 )} ) {h}_{2} + ( {c}_{3} {m}_{2}^{( 4 )} + {c}_{4} {m}_{4}^{( 4 )} ) {h}_{4} , \\ {m}_{3}^{( 8 )} = ( {c}_{4} {m}_{1}^{( 4 )} + {c}_{3} {m}_{3}^{( 4 )} ) {h}_{1} + ( {c}_{4} {m}_{2}^{( 4 )} + {c}_{3} {m}_{4}^{( 4 )} ) {h}_{3} , and \\ {m}_{4}^{( 8 )} = {m}_{2}^{( 8 )} {m}_{3}^{( 8 )} / {m}_{1}^{( 8 )} .$$

As a third pass transaction, at step 310, the process includes Alice receiving from Bob the matrices M₅, M₆, M₇ and M₈ as follows:

M₅=DY₁A₁C₁⁻¹,

M₆=C₁B₁Y⁻¹Z₁E,

M₇=E⁻¹Y₂A₂C₂⁻¹, and

M₈=CBY⁻¹XH.

Note that centrosymmetric matrices satisfy the following conditions:

AC⁻¹=C⁻¹A and

CB=BC,

meaning that the matrices M₅, M₆, M₇, and M₈ can be transformed into:

M₅=DY₁A₁C₁⁻¹=DY₁C₁⁻¹A₁,

M₆=C₁B₁Y₁⁻¹Z₁E=B₁C₁Y₁⁻¹Z₁E,

M₇=E⁻¹Y₂A₂C₂⁻¹=E⁻¹Y₂C₂⁻¹A₂,and

M₈=C₂B₂Y₂⁻¹Z₂H=B₂C₂⁻¹Z₂H.

Thus, at step 312, the process includes multiplying the matrices M₅, M₆, M₇ and M₈ with the known inverse matrices A₁⁻¹, A₂⁻¹, B₁⁻¹ and B₂⁻¹, respectively, as follows:

M₅A₁⁻¹=DY₂C₁⁻¹A₁A₁⁻¹=DY₁C₁⁻¹,

B₁⁻¹M₆=B₁⁻¹B₁C₁Y₁⁻¹Z₁E=C₁Y₁⁻¹Z₁E,

M₇A₂⁻¹=E⁻¹Y₂C₂⁻¹A₂A₂⁻¹=E⁻¹Y₂C₂⁻¹, and

B₂⁻¹M₈=B₂⁻¹B₂C₂Y₂⁻¹Z₂H=C₂Y₂⁻¹Z₂H.

Further, at step 314, the process includes multiplying the results of those together to arrive at the matrix M₅, as follows:

$${M}_{9} = {M}_{5} {A}_{1}^{- 1} {B}_{1}^{- 1} {M}_{6} {M}_{7} {A}_{2}^{- 1} {B}_{2}^{- 1} {M}_{8} , \\ {M}_{9} = {DY}_{1} {C}_{1}^{- 1} {C}_{1} {Y}_{1}^{- 1} {Z}_{1} {EE}^{- 1} {Y}_{2} {C}_{2}^{- 1} {C}_{2} {Y}_{2}^{- 1} {Z}_{2} H = {DZ}_{1} {Z}_{2} H , \\ such that \\ {M}_{9} = DXH , and \\ {M}_{9} = \vert \begin{matrix}{m}_{1}^{( 9 )} & {m}_{2}^{( 9 )} \\ {m}_{3}^{( 9 )} & {m}_{4}^{( 9 )}\end{matrix} \vert . \qquad ( 11 )$$

At step 316, the process includes Alice sending the following three publicly visible values to Bob (m₁⁽⁹⁾, m₂⁽⁹⁾, m₃⁽⁹⁾), as follows:

m₁⁽⁹⁾=(d₁x₁+d₂x₃)h₁+(d₁x₂+d₂x₄)h₃,

m₂⁽⁹⁾=(d₁x₁+d₂x₃)h₁+(d₁x₂+d₂x₄)h₄,

m₃⁽⁹⁾=(d₃x₁+d₄x₃)h₁+(d₃x₂+d₄x₄)h₃, and

m₄⁽⁹⁾=m₃⁽⁹⁾m₂⁽⁹⁾/m₁⁽⁹⁾.

Thus, as part of the final key restoration at step 316, Bob receives the matrix M9 from Alice, as follows:

M₉=DXH.

At step 318, the process includes Bob restoring the key X from Alice by using inverse matrices D⁻¹ and H⁻¹, which are known to Bob, and the matrix M₅, as follows:

D⁻¹M₉H⁻¹=D⁻¹DXHH⁻¹=X.

As shown in Table 6 below, the entire scheme of the key exchange process can be performed using an exchange of matrices with a corresponding number of different unknown independent variables (underlined in Table 6) and visible (by the third party) values (bolded in Table 6). This scheme demonstrates that the number of unknown independent variables always exceeds the number of visible independent values in any combination of subsets of matrices.

This means that the system of nonlinear equations is an indeterminate system. There are no algorithms for the third party to obtain unknown independent variables including the secret key X using the visible independent values.

TABLE 6

| | | | | Independent | | | |
|---|---|---|---|---|---|---|---|
| | | | Variables | Variables | | Values | |
| 1 | Alice | Y₁A₁ | A₁[2], Y₁[4] | 22 | M₁[4] | 4 | 14 |
| | | B₁Y₁⁻¹Z₁ | B₁[2], Z₁[3] | | M₂[4] | 3 | |
| | | Y₂A₂ | A₂[2], Y₂[4] | | M₃[4] | 4 | |
| | | B₂Y₂⁻¹Z₂ | B₂[2], Z₂[3] | | M₄[4] | 3 | |
| 2 | Bob | DY₁A₁C₁⁻¹ | D [4], C₁[2] | 16 | M₅[4] | 4 | 14 |
| | | C₁B₁Y₁⁻¹ Z₁E | E [4] | | M₆[4] | 3 | |
| | | E⁻¹Y₂A₂C₂⁻¹ | | | M₇[4] | 4 | |
| | | C₂B₂Y₂⁻¹ Z₂H | C₂[2], H[4] | | M₈[4] | 3 | |
| 3 | Alice | DXH | | | M₉[4] | 3 | 3 |

| | | |
|---|---|---|
| Total | 38 | 31 |

The direct restoration of the matrix X (using formula transformations of Eqs.3-11 is also impossible. Note that the matrix X is singular. It leads to several features, which are used to perform the key exchange algorithm resistant against the third party decryption (see APPENDIX):

The matrices M₂, M₄, M₆, M₈, and M₉

M₂=B₁Y₁⁻¹Z₁,

M₄=B₂Y₂⁻¹Z₂,

M₆=C₁B₁Y₁⁻¹Z₁E,

M₈=C₂B₂Y₂⁻¹Z₂H, and

M₉=DZ₁Z₂H

are also singular (due to the matrices Z₁ and Z₂ being singular).

Thus, the equation M₅L₁M₆M₇L₂M₈=M₉ (from the Eqs. 7-10) can not be resolved in regards to centrosymmetric matrices L₁=A₁⁻¹B₁⁻¹ and L₂=A₂⁻¹B₂⁻¹ by the third party as far as the matrix M₉ is singular so, the direct calculation X=M₁L₁M₂M₃L₂M₄ is not possible.

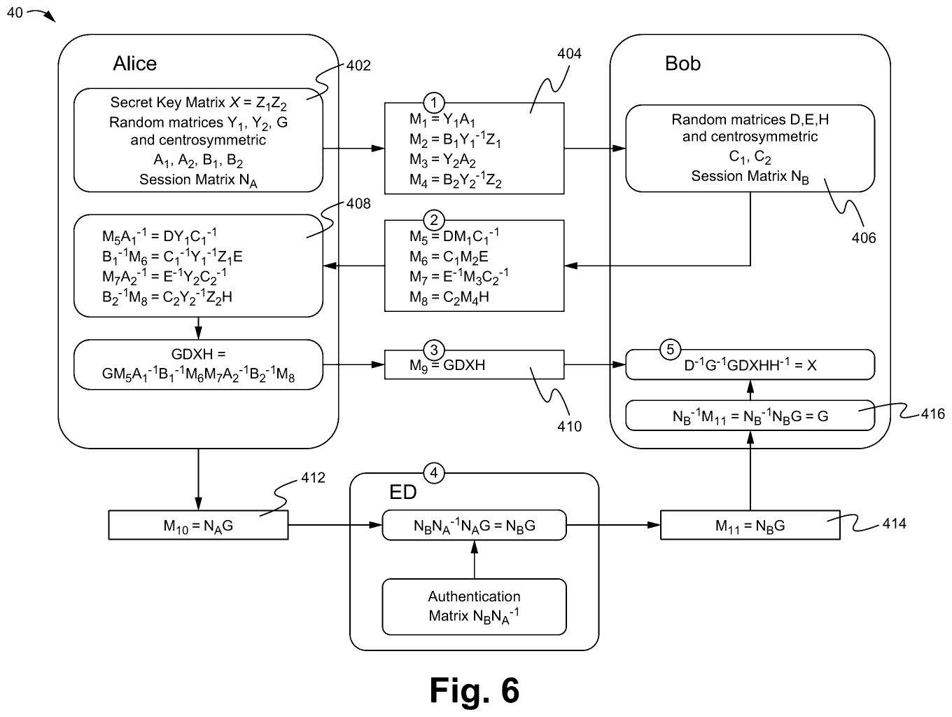

The concepts described herein can be used for other cryptographic operations, such as key exchanging using authentication. FIG. 6 illustrates an example secret material or key exchanging process using authentication according to the concepts described herein.

As shown in FIG. 6, Alice wants to pass the secret key K to Bob. They use Ed as an independent party for authentication. In the transaction, the square singular matrix

$$X = \vert \begin{matrix}{x}_{1} & {x}_{2} \\ {x}_{3} & {x}_{4}\end{matrix} \vert$$

is used to represent the key K={k₁, k₂, k₃}, where x₄=x₂x₃/x₁.

It is assumed that Alice and Bob both have passed the authentication procedure and both have got corresponding session numbers N₁^{A}, N₂^{A} and N₁^{B}, N₂^{B} from Ed according to the concepts described above.

Alice and Bob form centrosymmetric matrices N^{A} and N^{B} correspondently, as

$${N}_{A} = \vert \begin{matrix}{N}_{1}^{A} & {N}_{2}^{A} \\ {N}_{2}^{A} & {N}_{1}^{A}\end{matrix} \vert and {N}_{AB} = \vert \begin{matrix}{N}_{1}^{B} & {N}_{2}^{B} \\ {N}_{2}^{B} & {N}_{1}^{B}\end{matrix} \vert .$$

As part of a first pass transaction, at step 402, the process 40 includes Alice generating uniformly distributed random matrices Y₁, Y₂ and inverse matrices Y₁⁻¹, Y₂⁻¹, as follows:

$${Y}_{1} = \vert \begin{matrix}{Y}_{1} & {Y}_{2} \\ {Y}_{3} & {Y}_{4}\end{matrix} \vert , \\ {Y}_{1}^{- 1} = \frac{\vert \begin{matrix}{y}_{4} & - {y}_{2} \\ - {y}_{3} & {y}_{1}\end{matrix} \vert}{{y}_{1} {y}_{4} - {y}_{2} {y}_{3}} , {y}_{i} ∈ R , {y}_{1} {y}_{4} \neq {y}_{2} {y}_{3} , \\ {Y}_{2} = \vert \begin{matrix}{Y}_{5} & {Y}_{6} \\ {Y}_{7} & {Y}_{8}\end{matrix} \vert , \\ {Y}_{2}^{- 1} = \frac{\vert \begin{matrix}{y}_{8} & - {y}_{6} \\ - {y}_{7} & {y}_{5}\end{matrix} \vert}{{y}_{5} {y}_{8} - {y}_{6} {y}_{7}} , {y}_{i} ∈ R , {y}_{5} {y}_{8} \neq {y}_{6} {y}_{7} .$$

Alice also generates uniformly distributed random centrosymmetric matrices A and B, as follows:

$${A}_{1} = \vert \begin{matrix}{a}_{1} & {a}_{2} \\ {a}_{2} & {a}_{1}\end{matrix} \vert , \\ {A}_{2} = \vert \begin{matrix}{a}_{3} & {a}_{4} \\ {a}_{4} & {a}_{3}\end{matrix} \vert , \\ {A}_{1}^{- 1} = \frac{\vert \begin{matrix}{a}_{1} & - {a}_{2} \\ - {a}_{2} & {a}_{1}\end{matrix} \vert}{{a}_{1}^{2} - {a}_{2}^{2}} , \\ {A}_{2}^{- 1} = \frac{\vert \begin{matrix}{a}_{3} & - {a}_{4} \\ - {a}_{4} & {a}_{3}\end{matrix} \vert}{{a}_{3}^{2} - {a}_{4}^{2}} , {a}_{i} ∈ R , {a}_{1}^{2} \neq {a}_{2}^{2} , {a}_{3}^{2} \neq {a}_{4}^{2} , \\ {B}_{1} = \vert \begin{matrix}{b}_{1} & {b}_{2} \\ {b}_{2} & {b}_{1}\end{matrix} \vert , \\ {B}_{2} = \vert \begin{matrix}{b}_{3} & {b}_{4} \\ {b}_{4} & {b}_{3}\end{matrix} \vert , \\ {B}_{2}^{- 1} = \vert \begin{matrix}{b}_{3} & - {b}_{4} \\ - {b}_{4} & {b}_{3}\end{matrix} \vert , {b}_{i} ∈ R , {b}_{1}^{2} \neq {b}_{2}^{2} , {b}_{3}^{2} \neq {b}_{4}^{2} .$$

Note that any centrosymmetric square matrices A and B always have the following feature: AB=BA. At step 404, the process includes Alice sending to Bob results as matrices M₁ and M₂, as follows:

$${M}_{1} = \vert \begin{matrix}{m}_{1}^{( 1 )} & {m}_{2}^{( 1 )} \\ {m}_{3}^{( 1 )} & {m}_{4}^{( 1 )}\end{matrix} \vert ,$$

$${M}_{2} = \vert \begin{matrix}{m}_{1}^{( 2 )} & {m}_{2}^{( 2 )} \\ {m}_{3}^{( 2 )} & {m}_{4}^{( 2 )}\end{matrix} \vert ,$$

$${M}_{3} = \vert \begin{matrix}{m}_{1}^{( 3 )} & {m}_{2}^{( 3 )} \\ {m}_{3}^{( 3 )} & {m}_{4}^{( 3 )}\end{matrix} \vert ,$$

$${M}_{4} = \vert \begin{matrix}{m}_{1}^{( 4 )} & {m}_{2}^{( 4 )} \\ {m}_{3}^{( 4 )} & {m}_{4}^{( 4 )}\end{matrix} \vert .$$

of the following calculations:

M₁=Y₁A₁, (1B)

M₂=B₁Y₁⁻¹Z₁, (2B)

M₃=Y₂A₂, and (3B)

M₄=B₂Y₂⁻¹Z₂. (4B)

As part of a second pass transaction, at step 406, Bob receives M₁ and M₂ from Alice. Bob generates uniformly distributed random centrosymmetric matrices C₁, C₂ and inverse C₁⁻¹, C₂⁻¹ matrices, as follows:

$${C}_{1} = \vert \begin{matrix}{C}_{1} & {C}_{2} \\ {C}_{2} & {C}_{1}\end{matrix} \vert ,$$

$${C}_{2} = \vert \begin{matrix}{C}_{3} & {C}_{4} \\ {C}_{4} & {C}_{3}\end{matrix} \vert ,$$

$${C}_{1}^{- 1} = \frac{\vert \begin{matrix}{c}_{1} & - {c}_{2} \\ - {c}_{2} & {c}_{1}\end{matrix} \vert}{{c}_{1}^{2} - {c}_{2}^{2}} , {c}_{i} ∈ R , {c}_{1}^{2} \neq {c}_{2}^{2} ,$$

$$and {C}_{2}^{- 1} = \frac{\vert \begin{matrix}{c}_{3} & - {c}_{4} \\ - {c}_{4} & {c}_{3}\end{matrix} \vert}{{c}_{3}^{2} - {c}_{4}^{2}} , {c}_{i} ∈ R , {c}_{3}^{2} \neq {c}_{4}^{2} .$$

and uniformly distributed random matrices D and H, as follows:

$$D = \vert \begin{matrix}{d}_{1} & {d}_{2} \\ {d}_{3} & {d}_{4}\end{matrix} \vert , and$$

$$H = \vert \begin{matrix}{h}_{1} & {h}_{2} \\ {h}_{3} & {h}_{4}\end{matrix} \vert , {d}_{i} , {h}_{i} ∈ R , {d}_{1} {d}_{4} \neq {d}_{2} {d}_{3} , {h}_{1} {h}_{4} \neq {h}_{2} {h}_{3} ,$$

and correspondent inverse matrices D⁻¹ and H⁻¹, as follows:

$${D}^{- 1} = \frac{\vert \begin{matrix}{d}_{1} & {d}_{2} \\ {d}_{3} & {d}_{4}\end{matrix} \vert}{{d}_{1} {d}_{4} - {d}_{2} {d}_{3}} ,$$

$${H}^{- 1} = \frac{\vert \begin{matrix}{h}_{1} & {h}_{2} \\ {h}_{3} & {h}_{4}\end{matrix} \vert}{{h}_{1} {h}_{4} - {h}_{2} {h}_{3}} .$$

At step 406, Bob also obtains the matrices M₅, M₆, M₇ and M₈, defined as follows: as a result of the following calculations:

$${M}_{5} = \vert \begin{matrix}{m}_{1}^{( 5 )} & {m}_{2}^{( 5 )} \\ {m}_{3}^{( 5 )} & {m}_{4}^{( 5 )}\end{matrix} \vert ,$$

$${M}_{6} = \vert \begin{matrix}{m}_{1}^{( 6 )} & {m}_{2}^{( 6 )} \\ {m}_{3}^{( 6 )} & {m}_{4}^{( 6 )}\end{matrix} \vert ,$$

$${M}_{7} = \vert \begin{matrix}{m}_{1}^{( 7 )} & {m}_{2}^{( 7 )} \\ {m}_{3}^{( 7 )} & {m}_{4}^{( 7 )}\end{matrix} \vert ,$$

$${M}_{8} = \vert \begin{matrix}{m}_{1}^{( 8 )} & {m}_{2}^{( 8 )} \\ {m}_{3}^{( 8 )} & {m}_{4}^{( 8 )}\end{matrix} \vert .$$

as a result of the following calculations:

M₅=DM₁C₁⁻¹=D₁Y₁A₁C₁⁻¹, (5B)

M₆=C₁M₂E=C₁B₁Y⁻¹Z₁E, (6B)

M₇=E⁻¹M₃C₂⁻¹=E⁻¹YA₂C₂⁻¹, and (7B)

M₈=C₂M₄H=C₂B₂Y₂⁻¹Z₂H. (8B)

As part of a third pass transaction, at step 408, the process includes Alice generating a uniformly distributed random matrix G, as follows:

$$G = \vert \begin{matrix}{g}_{1} & {g}_{2} \\ {g}_{3} & {g}_{4}\end{matrix} \vert , {g}_{i} ∈ R .$$

Alice receives from Bob the matrices M₅, M₆, M₇ and M₈, as follows:

M₅=DY₁A₁C₁⁻¹=DY₁C₁⁻¹A₁,

M₆=C₁B₁Y₁⁻¹Z₁E=B₁C₁Y⁻¹Z₁E,

M₇=E⁻¹Y₂^{A}₂C₂⁻¹=E⁻¹Y₂C₂⁻¹A₂, and

M₈=C₂B₂Y₂⁻¹Z₂H=B₂C₂Y₂⁻¹Z₂H.

At step 408, the process also includes Alice multiplying both the matrices M₅, M₆, M₇ and M₈ with the inverse matrices which are known to her, A₁⁻¹, A₂⁻¹, B₁⁻¹ and B₂⁻¹, respectively, as follows:

$${B}_{1}^{- 1} {M}_{6} = {B}_{1}^{- 1} {B}_{1} {C}_{1} {Y}_{1}^{- 1} {Z}_{1} E = {C}_{1} {Y}_{1}^{- 1} {Z}_{1} E ,$$

$${B}_{1}^{- 1} {M}_{6} = {B}_{1}^{- 1} {B}_{1} {C}_{1} {Y}_{1}^{- 1} {Z}_{1} E = {C}_{1} {Y}_{1}^{- 1} {Z}_{1} E ,$$

$${M}_{7} {A}_{2}^{- 1} = {E}^{- 1} {Y}_{2} {C}_{2}^{- 1} {A}_{2} {A}_{2}^{- 1} = {E}^{- 1} {Y}_{2} {C}_{2}^{- 1} ,$$

$$and {B}_{2}^{- 1} {M}_{8} = {B}_{2}^{- 1} {B}_{2} {C}_{2} {Y}_{2}^{- 1} {Z}_{2} H = {C}_{2} {Y}_{2}^{- 1} {Z}_{2} H ,$$

$${M}_{5} = {GM}_{5} {A}_{2}^{- 1} {B}_{1}^{- 1} {M}_{6} {M}_{7} {A}_{2}^{- 1} {B}_{2}^{- 1} {M}_{8} = {GDY}_{1} {C}_{1}^{- 1} {C}_{1} {Y}_{1}^{- 1} {Z}_{1} E {E}^{- 1} {Y}_{2} {C}_{2}^{- 1} {C}_{2} {Y}_{2}^{- 1} {Z}_{2} H$$

$$such that {M}_{9} = GDXH , \qquad ( 9 B )$$

$$where {M}_{9} = \vert \begin{matrix}{m}_{1}^{( 9 )} & {m}_{2}^{( 9 )} \\ {m}_{3}^{( 9 )} & {m}_{4}^{( 9 )}\end{matrix} \vert .$$

At step 410, the process includes Alice sending three publicly visible values to Bob, including (m₁⁽⁹⁾, m₂⁽⁹⁾, m₃⁽⁹⁾). The matrix M₉ is singular and m₄⁽⁹⁾=m₃⁽⁹⁾m₂⁽⁹⁾/m₁⁽⁹⁾. At step 412, Alice also sends four publicly visible values to Ed (m₁⁽⁶⁾, m₂⁽⁶⁾, m₃⁽⁶⁾, m₄⁽⁶⁾) of the matrix M₁₀, defined as:

$${M}_{10} = \vert \begin{matrix}{m}_{1}^{( 10 )} & {m}_{2}^{( 10 )} \\ {m}_{3}^{( 10 )} & {m}_{4}^{( 10 )}\end{matrix} \vert ,$$

as a result of the following calculations:

M₁₀−N^{A}G. (9B)

For authentication, Ed receives the matrix M₆ from Alice. At step 414, Ed sends to Bob the matrix M₁₁ using the inverse matrix (N^{A})⁻¹ and the matrix N^{B}, as follows:

M₁₁=N^{B}(N_{A})⁻¹N^{A}G=N^{B}G,

M₁₁=N^{B}G. (10B)

As part of the final key restoration, at step 416, the process includes Bob receiving the matrix M₁₁ from Ed and obtaining the matrix G using the inverse matrix (N^{B})⁻¹, as follows:

G=(N^{B})⁻¹)M₁₁=(N^{B})⁻¹N^{B}G.

Bob also receives the matrix M₉ from Alice at step 410. Using inverse matrices G⁻¹, D⁻¹, and H⁻¹, which are known to Bob, he can restore the key X from the received matrix M₅ as follows:

D⁻¹G⁻¹M₉H⁻¹=D⁻¹G⁻¹GDXHH⁻¹=X.

### Low Power Encryption in Motion

In some embodiments, low power devices utilize the matrix encryption methods described herein. For example, low power encryption is able to involve the matrix-based key exchange which includes sending and receiving keys and equations and generating random numbers, wherein the keys and random numbers are utilized to solve the equations.

To minimize power usage, instead of performing authentication (e.g., a key exchange) for every packet, the windowing is able to be pushed out. For example, there is a key exchange once every nth packet (e.g., n=50) instead of every packet. The number of packets between each key exchange is able to be any number, while recognizing that the farther apart the key exchange, the less power usage but also a slight decrease in security. In some embodiments, a device is only awake for a short period of time and sleeps for a majority of the time. Additionally, a device is able to turn off as many components as possible that utilize power, and then the device is able to turn on the components when needed.

In some embodiments, an extension of the Bluetooth® protocol is implemented. The Bluetooth® protocol includes sending a signal 2-ways. A first signal is sent from a low power device (e.g., IoT device), and then a signal is sent to the low power device (e.g., received from the sending device). After the low power device sends a signal (e.g., a beacon or other 1-way transmission), the low power device listens for a short window/amount of time, and then goes to sleep to conserve power. Therefore, the low power device is asleep for approximately 99.9% of the time. During the short window, it may receive a 3-way handshake (e.g., perform the key exchange).

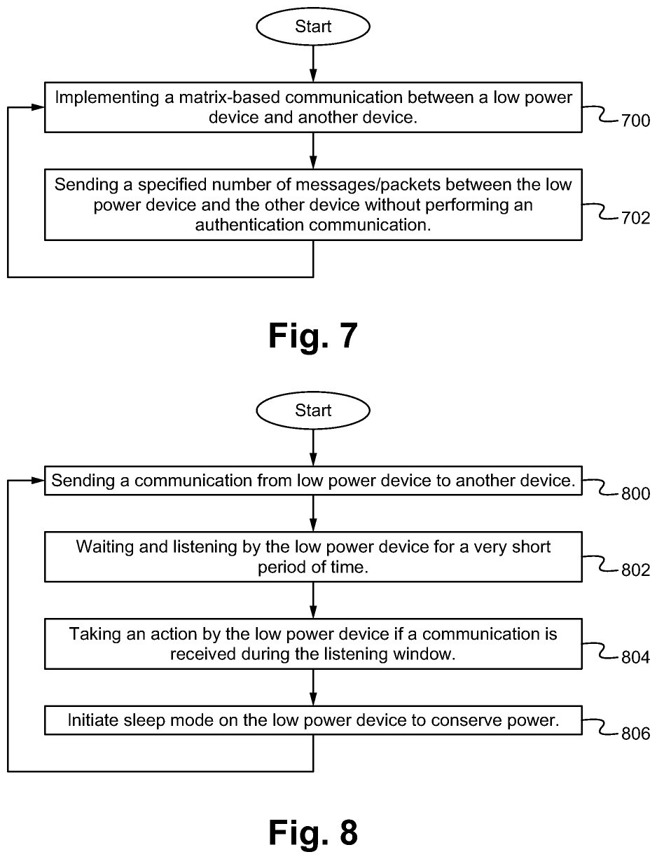

FIG. 7 illustrates a flowchart of a method of implementing low power encryption in motion according to some embodiments. In the step 700, a matrix-based communication is implemented between a low power device and another device. In some embodiments, the matrix-based communication includes a matrix-based key exchange. The low power device is able to be an IoT device and/or any other device which utilizes minimal power. For example, the low power device includes a battery which is charged initially and then is not charged again for many months or self-charges using ambient light and/or signals/waves. In another example, the low power device is powered by a battery or by collecting energy such as WiFi, kinetic vibrations or other ambient sources. The device communicating with the low power device is able to be any device such as a server, a user device, a backend device, or another IoT device. Included with or in addition to the matrix-based communication/key exchange is a message. For example, the low power device and the other device send messages including requests and/status information.

As described herein, the matrix-based communication involves real numbers and matrices. Secret information, X, is able to be sent with random number Y (e.g., X+Y) from a first device (e.g., Person A) to a second device (e.g., Person B). Then, a response is sent back from the second device to the first device, another random number Z is included but the secret information, X, is not included in the response, so instead of X+Y+Z, the response is just Y+Z. This is performed using matrices.

$$A = \vert \begin{matrix}{a}_{1} & {a}_{2} \\ {a}_{3} & {a}_{4}\end{matrix} \vert$$

$${X}_{s} = \vert \begin{matrix}{x}_{1} & {x}_{2} \\ {x}_{3} & \frac{{x}_{2} {x}_{3}}{{x}_{1}}\end{matrix} \vert$$

A·X=M, where M is a matrix.
A=X⁻¹M.
X is solvable if one knows A and M, but A is not solvable just by knowing X and M.
   For example, if Person A sends a message M to Person B and to Person C, where person B has information A and Person C has information M, then Person B has enough information to determine the message, but Person C does not.

Person A sends a function of matrix A and message X (e.g., F (A, X)) to Person B. Message 1 (M₁) equals the function, F(A, X). Person B returns back Message 2, M₂=F(A, X, B), where B is Matrix B. Person A removes matrix A, and sends Message 3, M₃=F (X, B), so that Person B receives the message X. In some embodiments, many more matrices (e.g., 8 or more matrices), more multiplications, and non-linear equations are utilized. Real numbers are utilized instead of integer numbers. Additionally, even if one were to determine Matrices A and B, the equation to solve for X is a diophantine 4^{th} order equation. Therefore, it is not solvable using an algorithmic approach, so brute force must be utilized, which means even a quantum computer would still take many years to decrypt a sufficiently encrypted message.

An authentication system is paired with the matrix-based encryption to ensure security. In the example of Person A exchanging a message X with person B, there is a three way key exchange. Random information (Matrix G) is added to the message, and Matrix G makes no sense even with a brute force attack. Additionally, Person A has his own authentication Matrix N₁, and Person B has his own authentication Matrix N₂. An authentication system is implemented which utilizes N₂·N₁⁻¹. Additionally, G is included with N₁ and N₂, so that if a third party attempts to access the information, they receive white noise. In some embodiments, the matrix-based encryption is utilized with RSA and/or ECC to perform quantum tunneling. Even if there is a virus on a device, since the virus is not registered on the authentication system, the virus will receive white noise when trying to access information.

In the step 702, a specified number of messages/packets are sent between the low power device and the other device without performing an authentication communication (e.g., a key exchange). For example, 50 packets are sent before the next matrix-based key exchange. A counter is able to be utilized to determine when to perform the next matrix-based messaging/key exchange. In some embodiments, a clock is utilized to determine when to perform the next matrix-based messaging/key exchange.

In some embodiments, fewer or additional steps are implemented. In some embodiments, the order of the steps is modified.

FIG. 8 illustrates a flowchart of another method of implementing low power encryption in motion according to some embodiments. In the step 800, a low power device sends a communication (e.g., signal) to another device. In some embodiments, the communication is a matrix-based communication as described herein.

In the step 802, the low power device waits and listens for a very short period of time (e.g., 1 second, 5 seconds, 5 minutes). While waiting and listening, the low power device is using power (e.g., to power the receiver).

In the step 804, if a communication is received during the listening window, the low power device takes an action. For example, the low power device and the other device may perform the matrix-based key exchange described herein. In another example, the low power device may be a sensor, and if another device sends a status request, the low power device may respond with status information after the matrix-based key exchange.

In the step 806, the low power device goes into sleep mode to conserve power. After the awake period or after an action is taken, the low power device enters sleep mode. The process repeats after a while by going back to step 800. For example, the low power device uses its internal clock or other mechanism to determine when to wake up and send another communication. By being in sleep most of the time (e.g., 99.9% of the time), the low power device significantly reduces its power consumption. In some embodiments, fewer or additional steps are implemented. For example, a low power device is configured and implemented to utilize less power such as by turning off certain components when not in use and by utilizing special sensors and power capturing/charging components configured to charge the low power device's battery. In some embodiments, the order of the steps is modified.

In some embodiments, the low power encryption in motion methods are utilized together. For example, the low power device sends a signal and waits/listens for a response during a short window, but only every nth window is there a key exchange. In this case since the window occurs infrequently, the nth window may be a lower number such as every 10^{th} time, although any number could be specified.

Key Exchange with Small Encrypted Payload

In some embodiments, low power devices utilize the matrix encryption methods described herein for encryption. Low power devices typically cannot send/receive large amounts of data since sending/receiving more data uses more power.

A communication device sends a signal/message (e.g., beacon) to a low power device (e.g., IoT device, credit card). In addition to or included with the message, the communication device is able to send a small amount of data (e.g., 20 bytes). For example, the message as a total (including keys, equations) is 20 bytes or fewer, or the message has a size limit, and the additional information (e.g., keys, equations) has a different size limit (e.g., 20 bytes). In some embodiments, the communication comprises a payload as small as 20 bytes or fewer. The payload size is able to be modified depending on a specification such as a Power Specification. There are multiple keys (e.g., k₁, k₂) at the communication device and multiple keys (e.g., k₁, k₂) at the low power device. The communication device and the low power device each have real number random number generators. Using the random number generators, one or more random numbers between 0 and 1 are able to be generated. Each random number is 4 bytes, so for 2 random numbers, there is a total of 8 bytes used. The following shows exemplary equations:

$${r}_{1} ( 1 - {k}_{1} ) + {r}_{2} {k}_{1} = {m}_{1}$$

$${r}_{1} ( 1 - {k}_{2} ) + {r}_{2} {k}_{2} = {m}_{2}$$

$${r}_{1} ( 1 - x ) + {r}_{2} x = {m}_{3}$$

$$x = \frac{[ {m}_{3} - {r}_{1} ]}{{r}_{2} - {r}_{1}}$$

where x is the message;
k₁ and k₂ are keys;
r₁ and r₂ are randomly generated numbers; and
m₁, m₂ and m₃ are real numbers between 0 and 1 calculated using the keys and randomly generated numbers. Additionally, m₁, m₂ and m₃ are functionally unrelated, such that if someone snoops and retrieves the values of m₁, m₂ and m₃, the snooper retrieves garbage data or white noise even if x is constant.

For example, the communication device sends the equations for m₁ and m₂, which are each 4 bytes, to the low power device. The communication device also sends the message or the equation for m₃ (which includes the message) which is also 4 bytes (meaning a total of 12 bytes for the 3 equations). The variables r₁ and r₂ are unknown by any third party. The variables r₁ and r₂ are then able to be determined/calculated by the low power device. In some embodiments, r₁ and r₂ are received by the low power device. The value/information of x (the message) is able to be decrypted by the low power device using r₁ and r₂ and the equations.

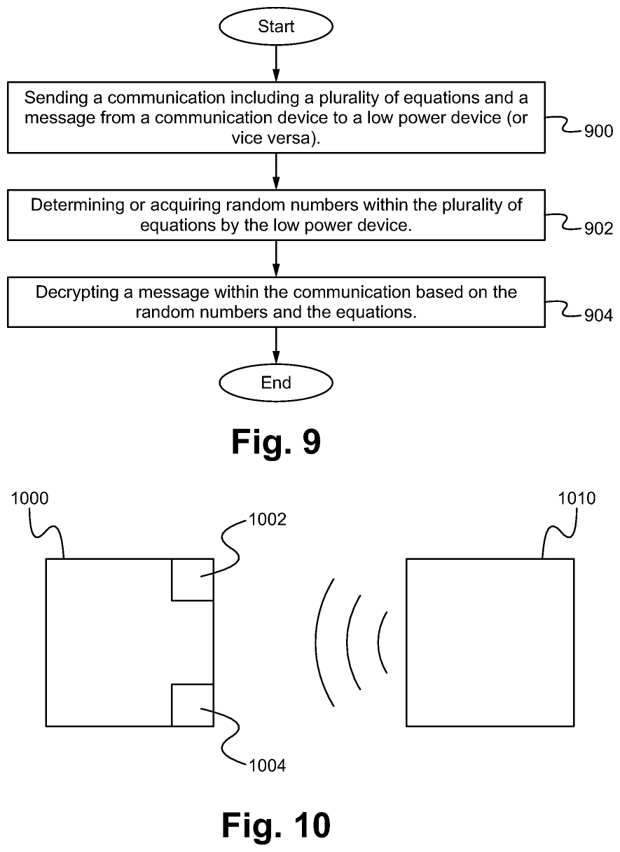

FIG. 9 illustrates a flowchart of a method of implementing low power encryption in motion according to some embodiments. In the step 900, a communication is sent from a communication device to a low power device (or vice versa). The communication includes an encrypted message and a plurality of equations. In some embodiments, the communication is limited in size (e.g., less than 20 bytes). The communication includes information that changes each communication such as a session identification number, a date/time stamp, and/or any other information to prevent a third party from capturing/copying a communication and sending the captured transmission. For example, the communication includes an identifier which counts up (e.g., for every package or is time-based), so that if the identifier is the same as or below a previous identifier, then the device knows that the communication is a duplicate, and is able to reject the communication and/or not respond.

In the step 902, random numbers within the plurality of equations are determined or acquired by the low power device. The random numbers are real numbers between 0 and 1, although other real numbers are able to be used. In some embodiments, the random numbers are received via the communication. In some embodiments, the random numbers are generated based on the communication using the random number generator on the low power device.

In the step 904, a message within the communication is decrypted based on the random numbers and the equations as described herein. In some embodiments, fewer or additional steps are implemented. In some embodiments, the order of the steps is modified.

FIG. 10 illustrates a diagram of a low power device in a communication system according to some embodiments. The low power device 1000 includes a transmitter/receiver 1002 (e.g., an antenna) to receive communications. The low power device 1000 is also able to include other components 1004 such as a battery (e.g., Lithium ion), one or more sensors, a processing unit, memory (e.g., RAM), one or more charging components (e.g., a small photovoltaic cell, a vibration converter) and other computing components. The one or more charging components are able to charge the battery using very small amounts of energy from energy sources such as ambient light, tiny vibrations, or wireless signals. The battery (along with the charging components) are configured such that the battery is able to be charged once and then maintain that charge for many months. The low power device 1000 is able to send/receive a communication (e.g., 1-way communication/data stream/beacon) as described herein. In some embodiments, the low power sends a communication periodically (e.g., once every 20 minutes). The communication is able to be RF, infrared, WiFi, Bluetooth, 5G (xG), or any other wireless communication. The low power device 1000 is able to communicate with any device 1010 (e.g., a mobile device, a server, another IoT device). In some embodiments, the low power device 1000 includes fewer or additional components.

### Encryption for 1-Way Data Stream

In some embodiments, encryption for a 1-way data stream is implemented. In some embodiments, as a device is provisioned, the 2-way exchange (e.g., two handshakes) with a second device is able to be implemented. Then, since the 2-way exchange with the second device has already occurred, the device is able to send 1-way data streams to the second device. The 1-way data stream is able to be a broadcast, cyphereye data, Bluetooth®, stream, coordinate information, and/or any other data.

FIG. 11 illustrates a diagram of a 1-way data stream encryption according to some embodiments. In the step 1100, a 2-way exchange (pre-registration) occurs between two devices (e.g., client and server). For example, the matrix-based exchange described herein occurs between a first device and a second device. After the 2-way exchange is performed, a device is able to send an encrypted 1-way data stream to the second device, in the step 1102. Since the pre-registration has established authentication/encryption credentials/information between the devices, the encrypted 1-way data stream is able to be decrypted by the second device, while being securely transmitted. In some embodiments, the 1-way data steam is from a mobile device, server, or other device to an Internet of Things device (or vice versa). In some embodiments, the 1-way data stream is status information (e.g., status of a sensor chip to a central station). In some embodiments, the 1 way-data stream includes instructions (e.g., from a central device to an IoT device to perform a specific type of monitoring or to go into a certain state/mode such as to go to sleep). In some embodiments, fewer or additional steps are implemented. In some embodiments, the order of the steps is modified.

### Dynamic Key Exchange for Moving Target

In some embodiments, a dynamic, matrix-based key exchange for a moving target is implemented. For example, a client (e.g., mobile device, autonomous vehicle) is moving and keeps switching between servers/receivers (e.g., devices positioned on light/telephone poles). In some embodiments, a dynamic key exchange registration is implemented where each time the signal drops at one receiver, the device connects with another receiver and performs another key exchange. In some embodiments, the device and/or receivers are pre-registered with an authentication server. In some embodiments, the device and/or receivers are registered (or pre-registered) with an authorization server, where the authorization server performs the processing and is able to send a decrypted message (based on an encrypted message from a receiver) to the device which forwards the message to another receiver (e.g., the server on the light pole), or the decrypted message is based on an encrypted message from a device, and the decrypted message is sent to the receiver. The receivers are able to send a 1-way data stream (e.g., beacon) to the moving device (or vice versa). In some embodiments, the device and/or receivers send a matrix-based encrypted communication to the receiver/device which forwards the communication to the authentication server which performs the decryption.

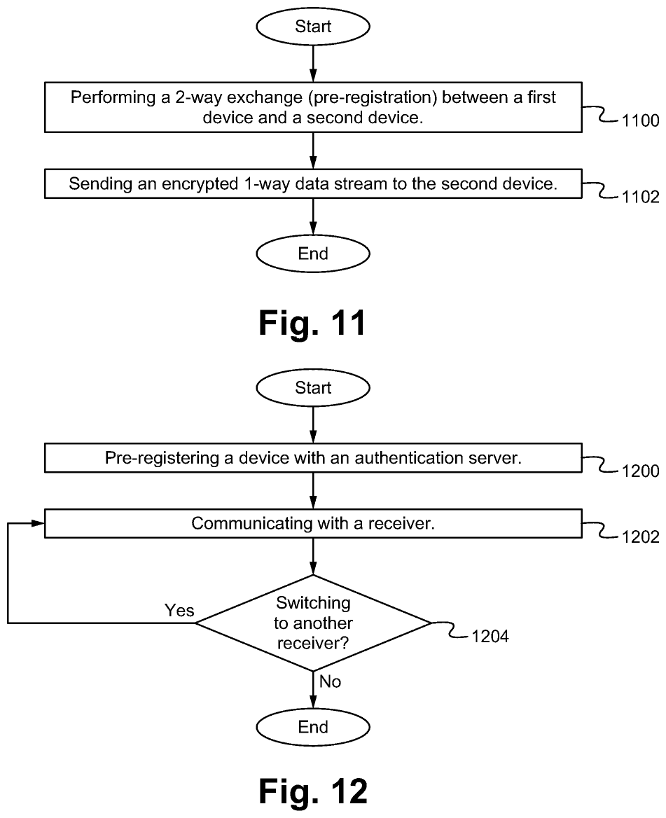

FIG. 12 illustrates a flowchart of a method of performing a dynamic key exchange for a moving target according to some embodiments. In the step 1200, a device is pre-registered with an authentication server. For example, the pre-registration described herein is implemented. In another example, pre-registration includes storing/recording device information (e.g., MAC address or other identification information) at the authentication server, so that the authentication server already “knows” the device. In some embodiments, other matrix-based encryption information is utilized for pre-registration. Similarly, the receiver is able to be pre-registered or registered with the authentication server. A pre-registered key or a dynamically-generated key is able to be used with the secure key exchange.

In the step 1202, the device communicates with a receiver. The communication is able to include a communication from the device to the receiver, a communication from the receiver to the device, or a combination thereof. Initially, a dynamic, matrix-based key exchange between the device and the receiver is implemented as described herein. In some embodiments, each time the device switches to a new receiver, the dynamic key exchange is performed again. In some embodiments, the authentication server is able to assist with the dynamic key exchange between the device and the receiver. For example, the authentication server assists with the authentication by performing the matrix-based key exchange computations and then provides the result to the device and/or the receiver. In another example, the authentication sever is able to perform the authentication with the device and/or the receivers such that the key exchange does not occur each time the device switches to a new receiver. In another example, the authentication server is able to store data to expedite the dynamic, matrix-based key exchange between the device and the receivers. Furthering the last example, if a device and/or receiver is verified or “known” by the authentication server, the authentication process/dynamic key exchange is able to be skipped or expedited. In some embodiments, the receiver forwards dynamic key information received from the device to the authentication server, and the authentication server performs the key analysis (e.g., matrix multiplication) to provide authentication data to the receiver and/or the device. Furthering the example, the device sends an encrypted communication to the receiver, but the receiver does not decrypt the communication; the receiver forwards the encrypted communication to the authentication server which performs the matrix-based decryption, and then takes another action such as returning the decrypted message to the receiver. After the device and/or receiver perform the dynamic key exchange, the message and/or messages are able to be acted upon. For example, if the dynamic key exchange accompanies a status request, a receiver is able to send a message back to the device with the status of the receiver. In another example, the messages to the receiver are able to include commands for the receiver to take a specified action. Similarly, the receiver is able to send commands to the device, and the device will take a specified action.

In the step 1204, the device determines whether to switch to another receiver. Determining when and whether to switch to another receiver is able to be implemented in any manner such as detecting that an ACK has not been received in response to a communication with the receiver, detecting a low signal strength from a receiver, utilizing a zone mapping which indicates which receiver services which zone, and/or any other manner. In some embodiments, when the device determines to switch to another receiver, the process resumes at the step 1202 to perform an authentication such as a dynamic key exchange. In some embodiments, the device does not determine whether to switch to a new receiver, and instead, the device broadcasts a communication, and whatever receiver is nearby receives the communication. The communication is encrypted as described herein, so receiver that receives the communication will still perform decryption. Similarly, the device is able to receive a communication from whichever receiver is nearby. In some embodiments, fewer or additional steps are implemented. In some embodiments, the order of the steps is modified.

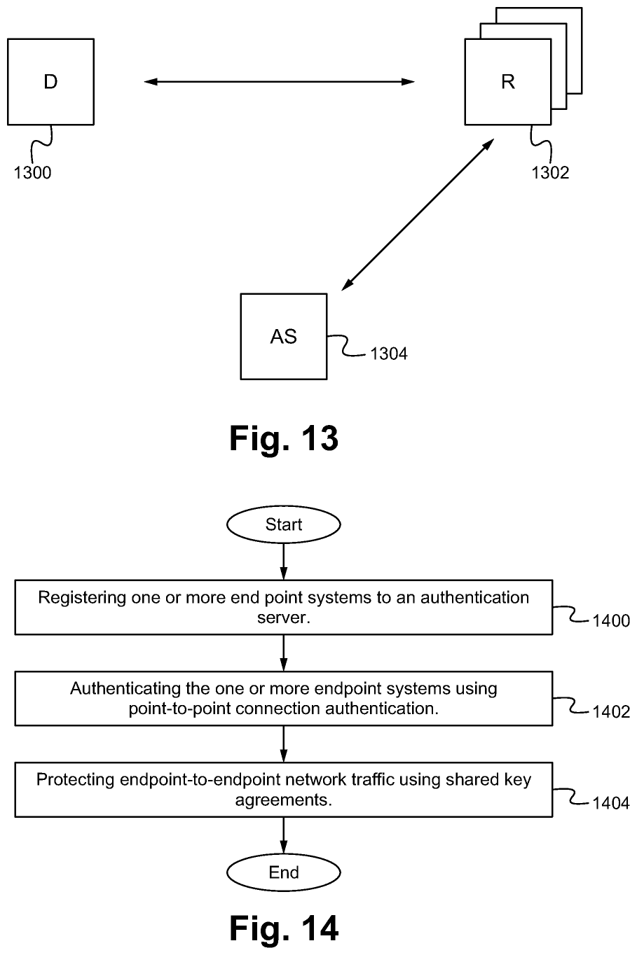

FIG. 13 illustrates a diagram of a system for implementing a dynamic key exchange for a moving target according to some embodiments. A device 1300 communicates with a set of receivers 1302. The device 1300 is able to be any device such as a mobile phone, an autonomous vehicle, an IoT device, a server or others. The receivers 1302 are able to be any device such as a mobile phone, an autonomous vehicle, a server, an IoT device, or others. An authentication server 1304 is able to be used to authenticate (or pre-authenticate) the device 1300 and/or the receivers 1302. In some embodiments, the authentication server 1304 is able to be used to authenticate (or pre-authenticate) the communication to/from the device 1300. In some embodiments, the device 1300 is able to communicate with the authentication server 1304, and/or the set of receivers 1302 are able to communicate with the authentication server 1304. The communication between each of the devices (e.g., device 1300, receivers 1302 and authentication server 1304) is able to be any implementation such as WiFi, cellular, 5G/xG, Bluetooth, and/or any combination thereof. The authentication server 1304 is able to be located anywhere such as at a central location.

In some embodiments, the device 1300 and/or the set of receivers 1302 are pre-registered with an authentication server 1304. Any form of pre-registration is able to be implemented. While the device 1300 is moving, the device 1300 will connect/communicate with several of the set of receivers 1302. The communication between the device 1300 and the set of receivers 1302 is secure. In some embodiments, the matrix-based key exchange is implemented each time the device 1300 connects with a receiver 1302. In some embodiments, the authentication sever 1304 performs the matrix-based key exchange by receiving the communication and accompanying matrix/encryption information, and provides access for the receiver 1302. For example, the device 1300 attempts to connect with a receiver 1302, so the matrix-based key exchange is implemented. The receiver 1302 passes the matrix information to the authentication server 1304, which performs the matrix processing (e.g., matrix multiplication), and provides the key information back to the receiver 1302 and/or the device 1300, so that the device 1300 and the receiver 1302 are able to communicate. In some embodiments, the authentication server 1304 is able to use the pre-registration information to bypass security protocols and/or to be utilized with the matrix-based key exchange. As the device 1300 moves and leaves range/signal of the receiver, the device 1300 communicates with another receiver in the set of receivers 1302. The matrix-based key exchange occurs with the other receiver, and so on with additional receivers. As described herein, determining when to switch to another receiver is able to be performed in any manner such as by detecting when a signal, quality of service, and/or speed of another receiver is higher than the current receiver, detecting when a distance of another receiver is lower than the current receiver, and others.

The architecture described herein includes the concept of network endpoints and devices being registered (onboarded) onto the authentication server system. Client software embedded onto endpoint systems work in conjunction with the authentication server and additional security technologies including digital signatures, key agreements and encapsulation and encryption techniques to generate a completely comprehensive and secure network.

The system is composed of several major processes:

Registration and authentication of endpoint systems. Registration and authentication manage the identification and security of endpoint systems for network access.

Point-to-Point connection authentication. Incoming network connection requests from endpoints which are not registered to the authentication server are therefore rejected. This includes several layer 2-7 protocols including low-level management network functions such as ICMP, DHCP and ARP.

Endpoint-to-Endpoint network traffic is optionally protected using any of several techniques using shared key agreements. This supports payload encryption, packet tampering protection, eavesdropping and network tapping prevention, system masquerading and spoofing, man-in-the-middle attacks and guaranteed payload integrity.

In some embodiments, authentication is required on only incoming connections. This allows support for network broadcast and multicast traffic.

FIG. 14 illustrates a flowchart of a method of authentication cryptography operations, exchanges and signatures according to some embodiments. In the step 1400, one or more endpoint systems are registered to an authentication server. Registering the one or more endpoint systems to the authentication server includes performing a secret key exchange. In some embodiments, the secret key exchange comprises a 3-way key exchange where two endpoint systems share secret data over a 3-way data exchange protocol. In some embodiments, the secret key exchange comprises utilizing XOR encryption and decryption. In the step 1402, the one or more endpoint system are authenticated using point-to-point connection authentication. In some embodiments, authenticating the one or more endpoint systems occurs only for incoming connections. In some embodiments, the one or more endpoint systems each include a cached list of authorized endpoints. In the step 1404, endpoint-to-endpoint network traffic is protected using shared key agreements. In some embodiments, fewer or additional steps are implemented. For example, a non-authorized endpoint system is rejected from a network connection. In some embodiments, the order of the steps is modified.

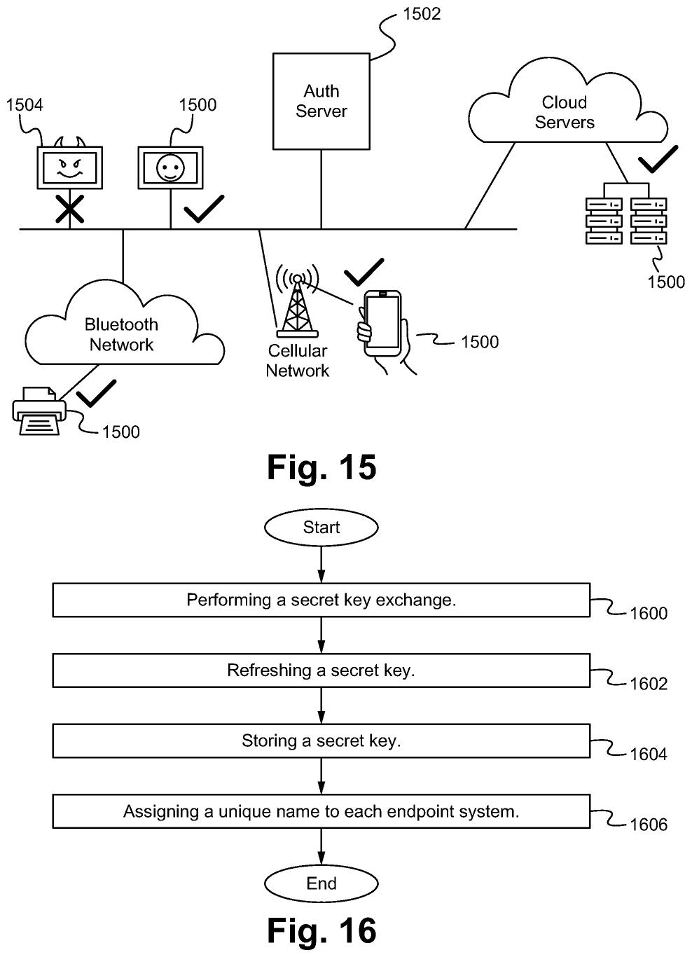

FIG. 15 illustrates a diagram of an architecture of a system to secure endpoints across various network LAN and WAN infrastructures according to some embodiments. The endpoints 1500 may be almost any network connected devices from large cloud systems and local servers, to desktops, printers, smartphones and even tiny IoT devices distributed over wireless network links. An authentication server 1502 is a centralized system which is populated with endpoint systems. A public name is the clear text name which is used to uniquely identify each endpoint system. This will often be a network address or network node name. A secret name is a unique endpoint system name which is encrypted before being exposed. Since network names such as addresses can be easily spoofed, the secret name is kept secret and encrypted when sent across the network. Only the endpoints and the authentication server have the decryption secret key to decrypt and view this secret endpoint name. A secret key is a unique encryption key which is generated and shared between each endpoint system and the authentication server. The secret key can be shared across insecure networks without ever exposing the key contents. The system prevents MAC spoofing, Man in the Middle/Replay attacks, impersonation and trespassing from bad actor systems 1504.

Registration

Each software or device endpoint is registered to the authentication server when onboarding to private networks. Registered devices can be authorized to communicate with each other, and bad actor systems will not be able to engage or interoperate with other authorized endpoints.

Onboarding systems into networks protected by authentication server domains is performed by an authorized administrator or a protected embedded or enclosed system. Examples of embedded systems include IoT gateway and manager systems.

FIG. 16 illustrates a flowchart of a method of registering endpoints by an authentication server when onboarding to a network according to some embodiments. In the step 1600, a new endpoint and the authentication server perform a secret key exchange. This will implement a shared key structure to support communications using symmetric encryption operations. The secret key exchange is performed on both the new system and on the authentication server(s). The secret key is randomized and designed to prevent duplicate collisions. In some embodiments, the key size is at least 256 bits to guarantee quantum resistance in subsequent operations. In the step 1602, the secret key is refreshed, replacing the keys on both ends. Refreshing the secret key is able to be implemented in any manner such as periodically or when a new endpoint is authorized or authenticated. In the step 1604, the secret keys are stored (e.g., inside system HSM hardware). In the step, 1606, each endpoint system being authorized is assigned a unique name. The unique name is able to be assigned by the authentication server or another device. The unique name is designed to be unique on the network. Secrecy of the unique name is not required. The unique name is stored in the authentication server and used to identify each endpoint. In some embodiments, fewer or additional steps are implemented. In some embodiments, the order of the steps is modified.

Authentication

For any endpoint-to-endpoint network communications, each incoming network connection is authorized. Non-authorized endpoint systems attempting to perform a network connection are rejected.

Software installed on each endpoint system contains a cached list of other authorized endpoints. Incoming network connections are compared with the local authorized systems managed by the authentication server.

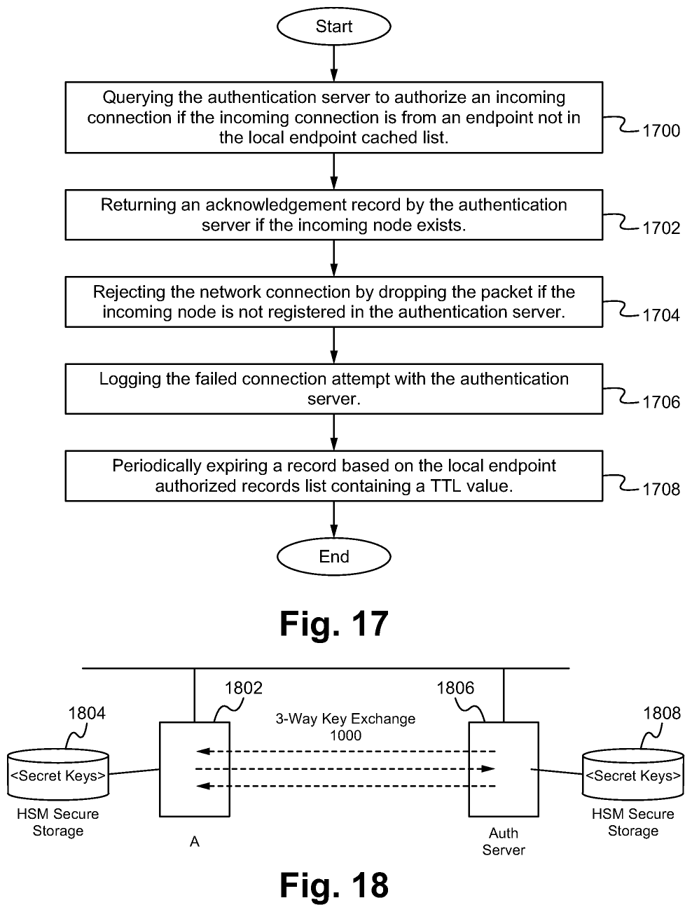

FIG. 17 illustrates a flowchart of a method of authentication according to some embodiments. In the step 1700, if the incoming connection is from an endpoint not in the local endpoint cached list, the node (e.g., endpoint) queries the authentication server to authorize the incoming connection.

In the step 1702, if the incoming node name exists at the authentication server, the authentication server returns an acknowledgment record. The acknowledgment record is then added to the endpoint local authorized nodes list, and the connection is completed. Then, network traffic is allowed.

In the step 1704, if the incoming node is not registered in the authentication server, the network connection is rejected by dropping the packet. Dropping the packet and not responding makes the endpoint “dark” on the network and not vulnerable to low-level network scans.

In the step 1706, the authentication server logs the failed connection attempt. This can be directed to log management systems to detect suspicious network incidents.

In the step 1708, the local endpoint authorized records list contains a Time-to-Live (TTL) value and periodically expires the record. Connections from this node involve re-authentication. The authorization refresh can be configured and increases the security level in cases where endpoint systems are possibly compromised. In some embodiments, fewer or additional steps are implemented. In some embodiments, the order of the steps is modified.

Authentication Server

Server administration for the authentication server is managed directly by human or automated system administrators. In some cases, endpoint registration may be ingested from other network management systems.

In some use case scenarios, the authentication server may be an embedded system.

For example, the authentication server is able to be embedded into the dashboard computer electronics controlling autonomous vehicles and IoT devices.

For authentication servers residing on public WAN networks, the server should be protected by standard TLS PKI systems using public/private certificates. This protects the authentication server from external security attacks including man-in-the-middle and other impersonation attacks.

Secret Key Exchange

FIG. 18 illustrates a diagram of an architecture of a system to perform a 3-way key exchange according to some embodiments.

The libraries contain a technology (both high-performance proprietary and other NIST standards) which perform quantum resistant secret key exchanges over unsecure public networks. A key agreement is a 3-way key exchange protocol 1800, where two endpoint systems (1802, 1806) share secret data over a 3-way data exchange protocol 1800.

At the end of the key exchange, both systems have identical secret keys (1804, 1808). During the exchange, the key is never exposed.

The keys on both systems are not exposed, so they are stored securely. This is similar to private certificate management in standard PKI practices. This is typically done using HSM hardware which is hardware backed secure storage. Examples of this technology include: FIPS hardware, TPM embedded systems, and others.

Hardware Security Modules (HSMs) are hardened, tamper-resistant hardware devices that strengthen encryption practices by generating keys, encrypting and decrypting data, and generating and verifying digital signatures.

Encrypted Communications Protocol

The communication between endpoints and other endpoints or the authentication server does not expose sensitive data elements. Security sensitive data, such as the endpoint database keys are encrypted using the shared secret keys (which are never exposed).

Endpoints can communicate with other endpoints or with the authentication server securely, even over public networks.

For some high-security environments, the data communications between systems can be further encrypted using symmetrical encryption technologies, such as AES or other encryption technologies. These encryption methods can use the existing shared secret keys established.

The technology has been optimized for high-speed LAN network segments using XOR encryption techniques. For WAN environments including the Internet, AES is not a noticeable performance issue.

Periodic Refresh

The shared keys are periodically refreshed with new keys. The refresh is performed to increase security by prevention of data from being harvested and attacked by external systems.

Packet Payload Encryption

Using endpoint to endpoint shared keys, the packet payload data can be encrypted with quantum resistant methods. This prevents eavesdropping of network traffic.

The technique can be performed at the datalink layers (e.g., Ethernet or Bluetooth), or at higher network layers such as IP packets.

Packet CRC/Hash Encryption

Another level of security to guarantee data integrity is using a technique where only interpacket CRC or only other hashes are encrypted.

This will guarantee data has not been tampered or altered. The advantages of this method are that it generates minimal performance overhead, but prevents packet data from being tampered with and from man-in-the-middle type attacks.

System Registration Protocol

Before endpoint systems can be allowed to communicate with other registered endpoints, each endpoint must be securely registered to the authentication server.

Each endpoint system has a public name, a secret name, and Time-To-Live (TTL) data elements.

The authentication server also stores the symmetric secret key for each endpoint.

Each endpoint system must be explicitly registered by an authorized system administrator with the authentication server.

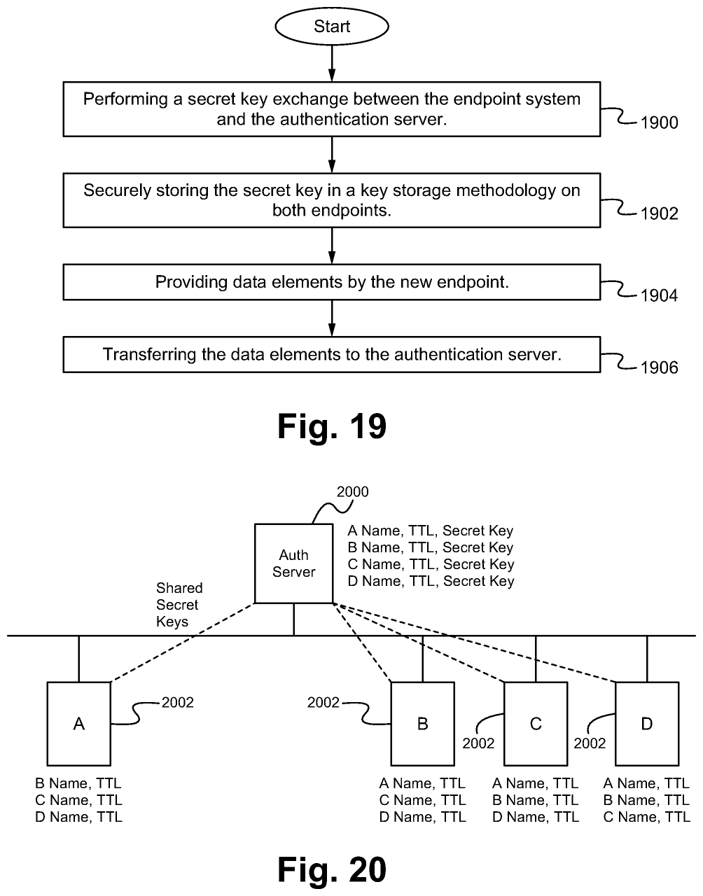

FIG. 19 illustrates a flowchart of a method of system registration according to some embodiments. In the step 1900, a secret key exchange is performed between the endpoint system and the authentication server. In the step 1902, the secret key is stored securely in a key storage methodology on both endpoints. In the step 1904, the new endpoint then provides the following data elements: a public name, a secret name and TTL. For Ethernet, a public name may be the MAC address. The secret name is known only by the endpoint and the authentication server. The TTL is provided as a policy by the system administrator. In some embodiment, the secret name is a 32 byte (or more) random string. The value can be auto-generated. The secret name is encrypted using an XOR operation with the secret key. This is what will be transmitted to the authentication server. Key to transmit: Secret Name XOR Secret Key. In the step 1906, the elements are transferred to the authentication server. The authentication server does not decrypt the secret name but stores the encrypted name. In some embodiments, fewer or additional steps are implemented. In some embodiments, the order of the steps is modified.

FIG. 20 illustrates a diagram of an authentication server and endpoints according to some embodiments. An authentication server 2000 stores public names, TTL and a secret key for each endpoint 2002. Each endpoint 2002 stores the public name of the other endpoints and TTL.

Endpoint Authentication Protocol

Endpoint authentication is the process which authenticates endpoints from incoming network packets, and either authorizes data communications or rejects connection attempts.

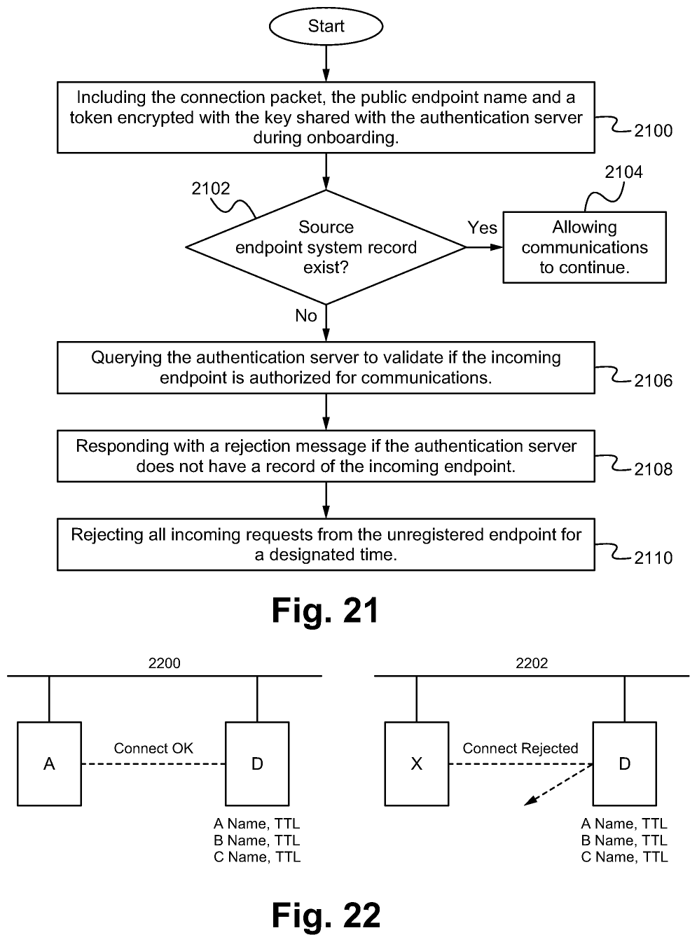

FIG. 21 illustrates a flowchart of a method of performing endpoint authentication by an endpoint according to some embodiments. When endpoints receive incoming connection requests, the endpoint performs several steps. In the step 2100, the source endpoint includes in the connection packet, the public endpoint name and a token encrypted with the key shared with the authentication server during onboarding. In the step 2102, the target endpoint checks if the source endpoint system is stored on the target endpoint system. This will reside in the target endpoint connection cache data records. In the step 2104, if the record exists, the source endpoint will have been authenticated prior against the authentication server, and the target endpoint allows communications to continue. In the step 2106, if the record does not exist, the endpoint queries the authentication server to validate if the incoming endpoint is authorized for communications. The public endpoint name and the encrypted token are sent to the authentication server. In the step 2108, if the authentication server does not have a record of the incoming endpoint, the authentication server responds with a rejection message. In the step 2110, the endpoint then rejects all incoming requests from this unregistered endpoint for a designated time defined by network policies. This prevents Denial of Service-type attacks. In some embodiments, fewer or additional steps are implemented. In some embodiments, the order of the steps is modified.

FIG. 22 illustrates a diagram of an accepted connection and a rejected connection according to some embodiments. Based on the steps performed by the endpoint, a connection is able to be accepted 2200 or rejected 2202.

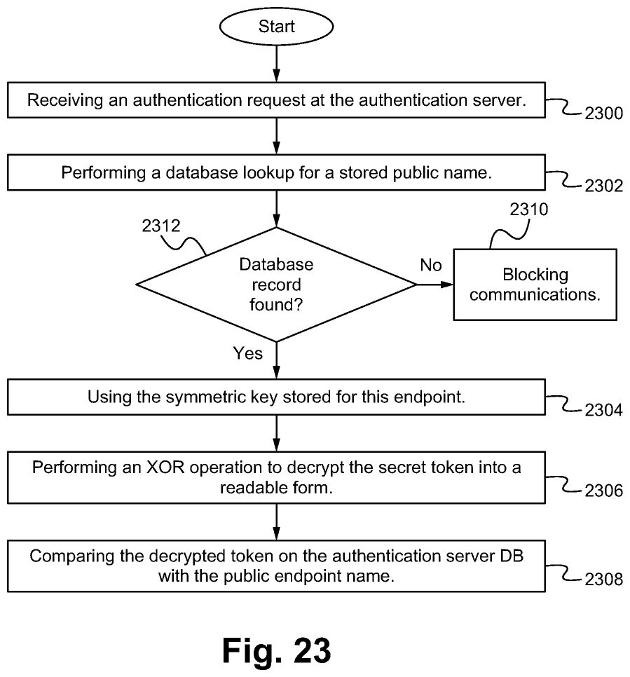

FIG. 23 illustrates a flowchart of a method of performing endpoint authentication by an authentication server according to some embodiments. In the step 2300, when the authentication server receives the authentication request from endpoints, the authentication server receives: the public name of the endpoint to authenticate and the secret encrypted token of the endpoint to authenticate. Examples of public names may be IP Addresses, Ethernet MAC addresses, Bluetooth addresses, or others, or these names may be user defined for the endpoint. The token is encrypted using the shared encryption key which was generated when the endpoint was onboarded onto the authentication server.

In the step 2302, the authentication server then performs a database lookup for the stored public name. If the database record is found, the authentication server: uses the secret symmetric key stored for this endpoint, in the step 2304, performs an XOR operation which will decrypt the secret token into a readable form (or potentially other encryption methods, but XOR is extremely compute efficient), in the step 2306, and the decrypted token is compared to the token on the authentication server DB associated with the public endpoint name, in the step 2308. If the decrypted token is the same as the stored token, the endpoint is considered valid and registered. If the database record is not found, then the endpoint is not authenticated, and communications are blocked, in the step 2310.

XOR Encryption and Decryption

XOR is a common technique to perform secure cryptographic functions with very low resource requirements. Doing an XOR operation includes:
Secret Name: abcde in binary is: 01100001 01100010 01100011 01100100 01100101;
Using a Secret Key of: 01010101 01010101 01010101 01010101 01010101;
The encrypted result is: 11001011 11001000 11001001 11001110 11001111;

When performing the XOR with the secret key again, the resultant is: 01100001 01100010 01100011 01100100 01100101, which is “abcde” in ASCII.

Using large enough keys (e.g., >32 bytes), the technique is extremely difficult to hack using brute force. The technique uses encryption keys that are the same length of the source data, which is appropriate for smaller sized data elements.

Denial of Service Prevention

When an endpoint incoming request is denied by the authentication server, the endpoint system will continue to reject all subsequent connection attempts for a specified time. This is to prevent Denial of Service type of attacks.

If a bad actor endpoint flooded another endpoint(s), and each connection attempt resulted in an authentication request to the authentication server, this would effectively overwhelm the authentication server and cause subsequent network disruptions. The authentication server is an important component of this network architecture and is protected from these kinds of threats.

Network Use Cases

The authentication system is able to use network names such as IP addresses, Ethernet MAC addresses, and various other network infrastructures.

Private networks environments such as LAN segments are able to implement the authentication system.

Public IP networks which can be routed by IP address are able to implement the authentication system. Many Internet networks use technologies which mask internal addresses, and as such are not uniquely addressable.

The authentication system is able to be used with Bluetooth, WiFi, IoT, Autonomous Cars, Smart Cities, the Metaverse, and other implementations.

Broadcast and Multicast

Since only incoming network connection requests are authenticated, broadcast and multicast traffic are authenticated using the same method. Incoming traffic is from a single endpoint and is processed and authenticated similarly.

Isolated Security Zones

This authentication system can be used to identify scopes of endpoints which are allowed to communicate. These zones can be identified as individual groups, and any groups not allowed to communicate within this group are isolated.

This is a valuable technique to generate secure zones of endpoints which can intercommunicate securely.

The method described herein is able to be implemented in a LAN environment. A LAN is able to include switches, routers, gateways, and other networking equipment. When a device attempts to communicate with another device in the LAN, several steps are performed. Initially, registration or pre-registration occurs. All of the nodes of the LAN are registered. Secret key exchange (using HSM, TPN, other hardware) is implemented as described herein. If a secret key exchange fails, then the communication is blocked (e.g., using XOR verification). Once a node is verified (pre-authorized), the process of verification is not performed again, and a node is able to communicate with another node (e.g., by using a pre-authenticated token).

To utilize the authentication system, a device sends or receives data using a Diophantine system. The authentication system is able to be implemented with user assistance or automatically without user involvement.

In operation, the authentication system enables the secure transmission of data from one device to another. For example, a user is able to communicate with another user without worry that a third party is going to intercept and view the contents of the communication. In another example, a device is able to communicate information (e.g., a password, banking information, private information) to another device in a secure manner.

The authentication system includes a network security methodology for preventing unauthorized access, packet tampering, network tapping and eavesdropping, man-in-the-middle and other security attacks. The network infrastructures are agnostic supporting a form of WAN and LAN network architectures.

The design objectives for the authentication system are:
1. High performance, high-scale and high-throughput performance with limited overhead and network delays.
2. Control of hardware or software endpoints that can connect and participate with other network resources. This is achieved by identifying unauthorized network guests and excluding them from communicating within the network.
3. Guarantee endpoint authenticity. Preventing authorized network endpoints from being impersonated or spoofed by malicious systems.
4. Prevention of Man-in-the-Middle and Replay-type attacks.
5. Network architecture agnostic-functional on a broad variety of network protocols and architectures including Ethernet, Internet Protocol, Bluetooth, RF Wireless, 5G cellular, and others.
6. Does not rely on specific hardware types or features, such as network switch or router security extensions. Any network hardware transports are supported, including fiber cabling, radio and carrier networks, and all layers of the OSI network stack protocols.
7. Designed for high throughput low latency performance with insignificant hardware overhead.
8. Able to be deployed in very small capacity devices like smartphones, IoT hardware, Bluetooth-attached devices as simple as mice and keyboards.
9. Endpoint systems equipped with this technology can be completely isolated from the rest of the network. Incoming connection requests are dropped and not detectable by other network systems.
10. Supports broadcast and multicast network communications.
11. Endpoint to endpoint security (optional advanced secure mode). Prevents network packet tampering where payload data is modified fraudulently. Fully encrypts network packet payload data.
12. Provides fully quantum resistant security solutions.

Any of the implementations described herein are able to be used with any of the other implementations described herein. In some embodiments, the implementations described herein are implemented on a single device (e.g., user device, IoT device, server, cloud device, backend device) and in some embodiments, the implementations are distributed across multiple devices, or a combination thereof.

The embodiments described herein can be implemented by either a method or process or as a system or device. The method can be performed using any suitable computing device, and the system can be embodied as any suitable computing device. The computing device can include at least one processing system, for example, having one or more processors and memories electrically and communicatively coupled together using a local interface. The local interface can be embodied as a data bus with an accompanying address/control bus or other addressing, control, and/or command lines.

In various embodiments, the memory can store data and software or executable code components executable by the processor. For example, the memory can store executable-code components associated with cryptographic operations for execution by the processor. The software or executable-code components can be developed using or embodied in various programming languages, such as, for example, C, C++, C#, Objective C, JAVA®, JAVASCRIPT®, Perl, PHP, VISUAL BASIC®, PYTHON®, RUBY, FLASH®, or other programming languages.

The embodiments can rely, in part, on executable instructions or instructions for execution by the computing device. The terms “executable” or “for execution” refer to software forms that can ultimately be run or executed by a processor, whether in source, object, machine, or other form. Examples of executable programs include, for example, a compiled program that can be translated into a machine code format and loaded into a random access portion of memory and executed by a processor, source code that can be expressed in an object code format and loaded into a random access portion of the memory and executed by the processor, or source code that can be interpreted by another executable program to generate instructions in a random access portion of the memory and executed by the processor, etc.

An executable program can be stored in any portion or component of the memory including, for example, a random access memory (RAM), read-only memory (ROM), magnetic or other hard disk drive, solid-state, semiconductor, or similar drive, universal serial bus (USB) flash drive, memory card, optical disc (e.g., compact disc (CD)) or digital versatile disc (DVD)), floppy disk, magnetic tape, or other memory component.

Although the process diagram shown in FIGS. 2 and 5 illustrate a certain order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any algorithm, method, process, or logic described herein that are embodied, at least in part, by software or executable-code components, can be embodied or stored in any tangible or non-transitory computer-readable medium or device for execution by an instruction execution system such as a general purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 2. In the context of the present disclosure, a “computer-readable medium” can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

### APPENDIX

### Matrix Properties:

1. The inverse matrix X⁻¹ of matrix

$$X = \vert \begin{matrix}{x}_{1} & {x}_{2} \\ {x}_{3} & {x}_{4}\end{matrix} \vert$$

is defined as follows:

$${X}^{- 1} = \frac{\vert \begin{matrix}{x}_{4} & - {x}_{2} \\ - {x}_{3} & {x}_{1}\end{matrix} \vert}{{x}_{1} {x}_{4} - {x}_{2} {x}_{3}} ,$$

$$and {XX}^{- 1} = {X}^{- 1} X = I ,$$

where I is the identity matrix,

$$I = \vert \begin{matrix}1 & 0 \\ 0 & 1\end{matrix} \vert .$$

2. In linear algebra and matrix mathematics, a centrosymmetric matrix is a matrix which is symmetric about its center. A centrosymmetric matrix A has the following form:

$$A = \vert \begin{matrix}{a}_{1} & {a}_{2} \\ {a}_{2} & {a}_{1}\end{matrix} \vert .$$

Centrosymmetric matrices A and B satisfy the following conditions:

AB=BA.
3. A square matrix is singular if and only if its determinant is 0. Because a square matrix formed from a random distribution of values will almost never be singular, singular matrices are rare. The matrix

$$X = \vert \begin{matrix}{x}_{1} & {x}_{2} \\ {x}_{3} & {x}_{4}\end{matrix} \vert$$

is singular if the determinant of the matrix X, det(X)=0 (e.g., x₄x₁−x₂x₃=0). In this case, the inverse X⁻¹ of the singular matrix X does not exist (division by zero). If the matrix X is singular, the matrix B=AX is also singular.

### Singular Matrix Features:

Consider a singular matrix S and an invertable, nondegenerate, or non-singular matrix V. The matrix W is also singular as a result of SV=W. The singular matrix S can be obtained if the matrices V and W are known, because S=WV⁻¹, but the non-singular matrix V=S⁻¹W can not be obtained even if matrices S and W are known because the inverse matrix S⁻¹ does not exist (division by zero). In this sense, “can not be obtained” means there is no unique solution of the equation (ambiguity).

We claim:

1. A method comprising:
performing a secret key exchange between a first device and a second device;
sending a communication from the first device to the second device, wherein the communication is encrypted; and
encrypting each interpacket hash of the communication to prevent data tampering.

2. The method of claim 1 wherein the secret key exchange comprises sharing one or more secret keys between the first device and the second device.

3. The method of claim 2 further comprising encrypting endpoint database keys with the one or more shared secret keys.

4. The method of claim 2 further comprising periodically refreshing the one or more secret keys.

5. The method of claim 1 wherein the first device comprises a first endpoint, and the second device comprises a second endpoint.

6. The method of claim 1 wherein the first device comprises an endpoint, and the second device comprises an authentication server.

7. The method of claim 1 wherein the communication is encrypted using a symmetrical encryption.

8. The method of claim 1 wherein the communication is encrypted using XOR encryption.

9. The method of claim 1 wherein each interpacket hash comprises a cyclic redundancy check.

10. An apparatus comprising:
a memory for storing an application, the application configured for:
performing a secret key exchange with a second device;
sending a communication to the second device, wherein the communication is encrypted; and
encrypting each interpacket hash of the communication to prevent data tampering; and
a processor configured for processing the application.

11. The apparatus of claim 10 wherein the secret key exchange comprises sharing one or more secret keys with the second device.

12. The apparatus of claim 11 wherein the application is configured for encrypting endpoint database keys with the one or more shared secret keys.

13. The apparatus of claim 11 wherein the application is configured for periodically refreshing the one or more secret keys.

14. The apparatus of claim 10 wherein the apparatus comprises a first endpoint, and the second device comprises an endpoint.

15. The apparatus of claim 10 wherein the apparatus comprises an endpoint, and the second device comprises an authentication server.

16. The apparatus of claim 10 wherein the communication is encrypted using a symmetrical encryption.

17. The apparatus of claim 10 wherein the communication is encrypted using XOR encryption.

18. The apparatus of claim 10 wherein each interpacket hash comprises a cyclic redundancy check.

19. A system comprising:
a first device; and
a second device, wherein the first device and the second device are configured for:
performing a secret key exchange;
sending and receiving communications, wherein the communications are encrypted; and
encrypting each interpacket hash of the communications to prevent data tampering.

20. The system of claim 19 wherein the secret key exchange comprises sharing one or more secret keys between the first device and the second device.

21. The system of claim 20 wherein the first device and the second device are configured for encrypting endpoint database keys with the one or more shared secret keys.

22. The system of claim 20 wherein the first device and the second device are configured for periodically refreshing the one or more secret keys.

23. The system of claim 19 wherein the first device comprises a first endpoint, and the second device comprises a second endpoint.

24. The system of claim 19 wherein the first device comprises an endpoint, and the second device comprises an authentication server.

25. The system of claim 19 wherein the communications are encrypted using a symmetrical encryption.

26. The system of claim 19 wherein the communications are encrypted using XOR encryption.

27. The system of claim 19 wherein each interpacket hash comprises a cyclic redundancy check.
